(19) United States
(12) Patent Application Publication
(10) Pub. No.: US 2026/0204442 A1
(43) Pub. Date: Jul. 16, 2026

(54) Multiplicative fission and converter Core for thermal and electrial generation

(71) Applicants: Alberto Mizrahy Campos, SR., Belo Horizonte (BR); Tarcisio Passos Ribeiro de Campos, SR., Belo Horizonte (BR)

(72) Inventors: Alberto Mizrahy Campos, SR., Belo Horizonte (BR); Tarcisio Passos Ribeiro de Campos, SR., Belo Horizonte (BR)

(21) Appl. No.: 18/861,401

(22) PCT Filed: Aug. 10, 2023
(86) PCT No.: PCT/BR2023/050257

§ 371 Date: Oct. 29, 2024

(51) Int. Cl. G21C 5/20; G21C 3/28; G21C 7/34; G21C 15/06; G21C 15/12

(52) U.S. Cl. CPC G21C 5/20; G21C 3/28; G21C 7/34; G21C 15/06; G21C 15/12

(57) ABSTRACT

The Multiplicative Fission and Conversion Core (MFCC), presented in 3 arrangements, is composed of various components, such as support (68, 69, 70), peripheral static reflector (10), static pre-moderator (15), and dynamic modulators (13, 24; 14) of the low-energy MB (13) and resonant MR (14) types. It includes a conversion chamber CC (11) and one or more fissile chambers CF (16, 17), both divided into compartments by MX(3) fertile material and MY (77) fissile material. There are independent cooling circuits for the target (20), CC (11), and CFs (16,17). The MFCC optimizes fission and radiative capture reactions in fertile materials Th232 or U238. It runs in either the Th232-U238 or U238-Am243 cycles, enabling fertile X nuclide conversion and fissile Y nuclide fission. Applications of MFCC include heat generation for heating and industry, as well as thermoelectric power generation.

### TECHNICAL FIELD

The present invention relates to the field of nuclear engineering, specifically to nuclear reactor cores, and the possibility of converting fertile elements into fissile ones, nuclear fission, generating heat and electricity for residential and industrial purposes.

### BACKGROUND ART

Nuclear reactors, equipped with uranium-based cores enriched with U235 that can hold critical or subcritical condition, thermal or fast spectra, have been in operation for seven decades as established technologies for thermonuclear energy generation.

In general, the fuel in thermal reactor cores consisting of fuel rods of 1-1.5 cm pitch filled with ceramic uranium pellets. These fuel rods hold together in rectangular or hexagonal fuel elements, immersed in a moderator and coolant, which can be either light water or distinct combinations such as light water/heavy water, graphite/CO₂, graphite/water vapor, among others.

Reactor cores are heterogeneous, with separate fuel and moderator components. In a thermal reactor, fast neutrons from U235 fission escape to the moderator, where neutrons slow down reaching thermal energies and then return by diffusion to the pellets in the fuel rods to induce thermal absorption or fission. This separation of moderator and fuel prevents the neutrons from trapping in the resonances of uranium's radiative absorption during the moderation processes.

In the multiplication K factor formula, in which a simplified K is p.e.n.f, one of the four factors is the parameter p, known as the resonance escape probability. In turn, the effective multiplication factor k_{ef} considers the leakage from geometry in both fast and thermal energies. Thus, the resonances of fuel elements are detrimental to the criticality of the reactor core and its operation. Therefore, the design of the reactor core provides neutron's escape of the fuel resonances, represented by a high p-factor.

Reactors generate a neutron flux with a Maxwell-Boltzmann spectrum spanning a wide energy range, from 0.01 eV up to 14 MeV. These neutrons arise from fission reactions and once moderated, they display continuous, isotropic, and diffusive fluxes, in the thermal, epithermal, and fast energy domain.

Depending on the type of reactor core, either thermal or fast spectra can predominate, with no limitations. The neutron fluency within a critical or subcritical reactor core exposes all internal nuclides. Consequently, reaction rates are proportional to the neutron fluency, the atomic densities of the elements, and the various microscopic cross-sections (XS) associated with all interactions within their components and materials. In general, there is no technology capable of selectively limiting neutron spectrum interactions with materials in the reactor cores. Indeed, there is no core that runs predominantly or preferentially within a resonance neutron spectrum.

Therefore, reactor cores generate a high concentration of radioactive contaminants, along with short and long-lived fission products, which accumulate throughout the fuel burning cycle. Additionally, there are temporary burnable poisons that hinder the maintenance of reactor criticality. To keep the criticality's delicate stability (k_{ef} unitary) throughout the entire fuel cycle and counteract the buildup of undesirable nuclides, the core composition must incorporate abundantly enriched fissile elements and pre-installed additional absorbers. The design of these absorbers allows full consumption during the fuel burning cycle, thus ensuring the necessary balance.

Reactor cores run with fissile elements such as U233 and U235. In thermal reactors, Uranium fuels often have an isotopic U235 enrichment level of 3-5%, which is higher than the natural abundance of 0.7%. An example of such fuel is in PWR (Pressurized Water Reactor) reactors.

Reactors can be breeders, capable of transforming fertile elements into fissile ones. However, to do so, they require a high neutron production to support core criticality and supply neutron excess for the conversion of Th-232 into U-233 or U-238 into Pu-239. This conversion takes place at the periphery of the core, in blankets made of fertile elements that capture escaping neutrons. Nevertheless, these reactors support criticality (k_{ef} unitary) using enriched U-235. The converted fissile elements may burn in other reactors after reprocessing.

Reactor cores hold a significant inventory of fissile elements, which burns throughout the typical fuel cycle, usually lasting three years, keeping a stable k_{ef} criticality during the cycle. Sudden instability can lead to subcriticality, resulting in the shutdown of the unit, or to supercriticality, which can potentially cause nuclear accidents, as seen in the Chernobyl Power Plant, resulting in long-lasting environmental damage.

The time dynamics of k_{ef}, in response to changes in nuclide concentrations within the reactor core, can be extremely rapid, occurring in fractions of a second. This poses a challenge for the implementation of safety systems in nuclear power plants, as it presents an inherent risk within current nuclear systems.

In the Nuclear Reactor Analysis by Duderstadt, James J., and Hamilton, Louis J. (John Wiley & Sons, Inc., Michigan, 1976), the authors supply a comprehensive description of the nuclear interactions between elements and the neutron spectrum found within reactor cores. This literature stands for innovative knowledge and expertise in the field of nuclear reactor engineering.

### SUMMARY OF INVENTION

The present invention describes an equipment, referred to as Multiplicative Fission and Conversion Core—MFCC, which is a nuclear unit equivalent to a reactor core that supports, in a controlled and continuous operation, the nuclear fission reaction and conversion of fertile elements.

The primary components of the MFCC are modulators consisting of solid cylindrical halos with diameters R. These halos rotate at an angular velocity w to change the neutron energy spectrum emitted by an internal source. The modulators replicate distinct normal distributions of neutrons on the peripheral surface, characterized by an average energy Eₘ and a standard deviation σ. These distributions optimize the reaction rate by meeting the fission cross-section (XS) requirements of fissile elements and the radiative capture (n,γ) cross-section requirements of the fertile element at different spatial positions.

The MFCC operates in the Th232-U238 cycle, in which the fertile element Th232 converts to fissile material and then transfers to the unit responsible for undergoing fission of the generated fissile products.

The MFCC can also run in the U238-Am243 cycle, in which the fertile element U238 converts to U239 and subsequent isotopes, which decay into Pa isotopes and then into U233 and U235, and so on. These isotopes fuel the unit responsible for conducting the fission reaction of the generated fissile products.

The MFCC has a conversion module—MC (1), one or more multiplicative fission modules—MF (2), and a pulsed neutron source module—MS (4), supporting radial symmetry.

The MFCC is an invention that allows radiative capture reactions to take place in fertile nuclides such as Th-232 or U-238 within the conversion chamber CC (11), transforming them into fissile materials that then go ahead to the fission chambers CFs (16, 17) where continuous fission occurs.

The MFCC directs and adjusts the energy of neutrons from a pulsed source FP (20), generating optimized characteristic spectra for sustaining multiplicative fission. It sequentially amplifies neutron fluence while directing it towards the conversion of fertile elements into fissile ones.

The optimization of the conversion rate occurs by favoring nuclear radiative capture reactions (n,γ) of the fertile element in the CC(11) chamber adjusting the average energy of a neutron distribution to a nuclear resonance spectrum. In the CFs, fission (n,f) occurs with an average energy of a neutron distribution adjusted to the extremely low energy range at cold neutrons or at fission resonance energies, promoting fissile reactions on nuclides with high cross-section XS behavior of 1/v at low energy or at resonances spectrum. This reduces absorption rates in regions outside the XS spectrum for the present isotopes and other nuclides with different XS behavior.

### Technical Problem

The reactor cores of Light Water Reactors (LWRs) hold enriched U235 to achieve criticality at a sufficient level throughout the entire burning cycle. The pre-installed absorber rods in the reactor core compensate for the excess of fissile material at the beginning of the cycle.

The nuclear industry must enrich natural uranium by increasing the isotopic abundance of U-235 in the fuel rods. This pre-processing procedure is costly and technologically sophisticated, and along with fuel reprocessing, it contributes to nuclear weapons proliferation.

There are no reactor cores that run solely with fertile elements, such as Th232 or U238, without the presence of highly enriched U-235 or Pu-240, beyond natural levels when cooled and moderated by light water. Additionally, in each cycle, typically lasting three years, fresh fuel replaces the burning fissile elements.

Thorium, which is four times more abundant in nature than uranium, holds untapped energy potential. However, the transmutation of Th-232 (n,γ) with subsequent production of fissile Pa and U isotopes in nuclear reactors is still in investigation for breeder reactor types, without general commercial application yet.

The drawback of nuclear technology lies in the accumulation of fission products generated by nuclear reactors, which increases with the mixed burnup cycle within the fuel itself. The radiation and heat from these fission products initially stored in nuclear power plants make the system radiologically unsafe. The safety of nuclear reactors is in question due to the major nuclear accidents, namely “Three Mile Island” (USA), “Chernobyl” (former USSR), and “Fukushima” (Japan), which caused severe damage to populations surrounding the plants and the environment. As a safe issue example, Germany, which had a robust nuclear program, chose to shut down all its nuclear reactors and now heavily relies on gas for heating.

The reactor core kept the spent fuel, having U235 and Pu239, transuranic elements, and the fission products (FP), during the burnup cycle of the fissile elements. Such contaminants are later transferred to the reactor pools at each cycle. It is impossible to separate, segregate, or reuse the fuel during the cycle.

The decommissioning of a nuclear power plant is a complex and costly process for which countries still lack experience. Due to the accumulation of radioactive waste in the facilities, there is high radiological contamination of the mechanical systems in the plant, and the disassembly and disposal methods are still uncertain. (IAEA Safety Standards Series No. SSG-40; IAEA-TECDOC-1755)

The production of nuclear energy in thermal or fast reactors generates radioactive waste, regardless of the fuel cycle or burnup time, using any current technology. The reactor core accumulates these wastes mixed within the fuel rod.

### Solution to Problem

The proposed innovative technology modulates the energy spectrum and angular direction of neutrons, spatially limiting them within the nuclear system. This invention exposes a portion of the cross-sections (XS) of fertile elements to undergo radiative capture (n,γ) in a specific chamber, while exposing fissile elements to fission (n,f) in another limited energy spectrum within a distinct chamber. This enables controlled and restricted interactions with their target nuclides in distinct spatial regions and specific energy spectra.

This technology runs in an unprecedented manner, prioritizing spectral regions that favor nuclear resonances for fission in fissile elements and radiative transmutation in fertile elements. The energy of neutrons in this equipment drives toward and selectively exploits these resonances in a controlled manner rather than escaping from them.

The solution to this problem is achieved through a combination of pre-moderators and rotating modulators with specific angular velocities and radius. These components optimize the adjustment and production of selective neutron spectra, allowing them to react with each targeted nuclide present in specific spatial regions. Nuclides outside of this spectrum or spatial region become inert in terms of transmutation and fission, reducing generated contamination.

Furthermore, the MFCC produces its own fissile elements through continuous conversion of fertile elements. During operation, the MFCC converts fertile material into fissile material and facilitates fission in sufficient quantities without accumulating fissile elements within the module. Therefore, there is no need to add fissile elements during operation, MFCC produces its own fissile material.

The MFCC also allows for the presence of a multiplicative factor k_{ef} in the fission chambers, where fission occurs. The criticality's dynamics within these chambers are inherently slow, governed by the production time of fissile elements, which typically takes hours to days. This production is naturally controlled by the radioactive decay half-lives, such as Th-233→Pa-233→U-233 and Th-234→Pa-234→U-234 in the Thorium cycle, or U-239→Np-239→Pu-239 and U-240→Np-240→Pu-240 in the Uranium cycle, among others, present in the conversion from fertile to fissile elements.

The MFCC operates with fertile elements that, when in concentration's equilibrium, do not require the addition of enriched fissile elements during operation, as it generates its own fissile fuel. Additionally, the MFCC does not accumulate fissile nuclides. When coupled with a complementary RSS system in sending patent (PCT/BR2023/050225, Date of Receipt: 1 Jul. 2023, Receiving Office: National Institute of Industrial Property (Brazil)) WIPO), the MFCC can continuously treat its own radioactive waste, which consists of fission products PF.

The MFCC, in terms of its geometry, components, material composition, and operation, differs significantly from current nuclear reactor core technologies. In MFCC, the coolant circuitry is fully separate from fuel fluid. The fuel fluid holds only consumable fissile nuclide and its fission products, whose PF can be removed and decontaminated online.

This patent stands for a change in basic assumptions in nuclear technological development, resolving serious safety, radiological, and environmental issues associated with the nuclear industry.

### Advantageous Effects of Invention

MFCC is a modular equipment with separate physical and functional parts that are replicable. As a result, both installation and decommissioning of the parts become easy to perform

After reaching the equilibrium of atomic concentrations of the nuclides generated over time, the MFCC starts converting fertile elements (X) into fissile elements (Y) that are self-produced and consumed while fertile elements are present, and the pulsed source module generates primarily neutrons.

The MFCC, in equilibrium of the concentrations of fissile nuclides in the fission chambers, runs solely with Th232 or natural U238, without additional isotopic enrichment. This unique condition is the production of the neutron distributions with an average energy tailored to the highest XS (n,f) of fissile nuclides and XS (n,γ) of fertile nuclides. This intensification of the nuclear system's response effectively reduces the need for enrichment.

To reduce the time needed to achieve the equilibrium of fertile-fissile concentrations, it is possible to introduce fissile elements to start the operation of the MFCC that starts in equilibrium of fertile-fissile concentrations.

The MFCC operates in optimized selective neutron spectra within the resonance range, minimizing the generation of more radioactive contaminants apart from the final products.

The MFCC, combined with the RSS configurations arrangement (submitting patent PCT/BR2023/050225, Date of Receipt: 1 Jul. 2023, Receiving Office: National Institute of Industrial Property Brazil), represents a novel type of nuclear system for nuclear energy production, where self-conversion of fertile to fissile elements, consumption of fissile elements, and burning of radioactive waste occur through MFCC and complementary RSS units.

The multiplicative effect occurring in the fission chambers CFs (16, 17). It can be amplified by increasing the number of fission modules—MF, increasing the thickness of static moderators in contact with the CFs, increasing the intensity of the pulsed source—FP, and extending the fluid's residence time with fissile elements in CFs.

The long natural conversion time of fertile elements to fissile elements, characterized by the β-decay half-lives of nuclides Th233, Th234, Pa233, Pa234; or U239, U240, Np239, Np240, limits and slows the dynamics of the multiplicative factor k_{ef} dynamics of the multiplicative factor.

The technology is non-proliferative as it produces and consumes the generated fissile nuclides and reduces the production of transuranic.

The MFCC invention runs in equilibrium of fertile-fissile nuclide concentrations, whether in subcritical or critical conditions. It enables the generation of heat and, consequently, thermoelectric energy through nuclear fission using fertile elements such as Th-232 or natural or depleted uranium. This technology does not require enrichment by fissile elements due to its optimized ability for self-conversion of fertile elements and fission of the converted products.

### BRIEF DESCRIPTION OF DRAWINGS

FIG. 1

FIG. 1 presents the constituent modules of MFCC, namely (A) Conversion Module—MC (1), Fission Module—MF (2), and Source Module—MS (4); and (B) supplies details of MC's constituents.

FIG. 2

FIG. 2 illustrates the MF's components, showing (A) the possible MF (2, 18) repetitions, and (B) the two options for MF (2) components {MK(5), CF(16), MB(13)} and {MK (5), CF(16), MR(14), PMB(24)}.

FIG. 3

FIG. 3 illustrates MFCC1 arrangement with {MC(2), MF(2), MS(4)} modules composing a single unit, with interleaved CC(11) and CF(16) chambers.

FIG. 4

FIG. 4 illustrates MFCC2 arrangement following a condition of {MC(1), MS(4)} and {MF(2), MS(4)} modules running independently in parallel, with fluid crossing (8) from CC(11) to CF(16).

FIG. 5

FIG. 5 illustrates MFCC3 in a special condition where a single module M exists, assuming operation of either MC(1) conversion or MF(2) fission, depending on the wₙ rotational values at distinct operation time O.T., T1 and T2.

FIG. 6

FIG. 6 illustrates a diagram of the transport of the flows of a collecting fluid, from inlet (46) to outlet (59), the cooling fluid flows in CC(11) and in CF(16) chambers, including the heat exchangers and the FdT working fluid.

FIG. 7

FIG. 7 illustrates a diagram of the fresh Fd and contaminated FdC collecting fluids (35) flowing, and the cooling-fluids (31, 32, 33) among MFCC and the CPM chemical processing module (39), the heat exchangers (HEs) and turbine TB.

FIG. 8

FIG. 8 illustrates a MFCC1 lateral 3D view depicting the main external components.

FIG. 9

FIG. 9 illustrates the tube's rings of the collecting fluid (47), the cooling-fluid (49) for the CC(11) and CF(16) chambers, and the cooling-fluid (44) for the accelerator target, including heat exchangers, all enclosed on the MFCC1.

FIG. 10

FIG. 10 depicts separately (A) the collecting fluid circuit Cc (6) and (B, C) the circuits of cooling fluids HC_{A}, HC_{CC}, HC_{C}.

FIG. 11

FIG. 11 illustrates the top, lateral and base supports of the representation of MFCC1, including speed motor positions.

FIG. 12

FIG. 12 depicts the time-dependent atomic densities of the fertile and conversion's products for MFCC operation in (a) Th232 and (b) U238 cycles.

FIG. 13

FIG. 13 shows the thermal energy generation in function of operating time for a specific MFCC operating in (a) Th232 and (b) U238 cycles, depicting the transition of the achievement of the equilibrium's concentration following by time continuing operation.

FIG. 14

FIG. 14 depicts (A) Eₘ of the Dₙ(Eₘ, σ) taken in discrete radial intervals, and (B) Eₘ of Dₙ(Eₘ, σ) up to 100 bins, depicting 1 and 4 cases, both in function of R interval.

FIG. 15

FIG. 15 depicts the data from MR design with graphite and zirconyl.

### DESCRIPTION OF EMBODIMENTS

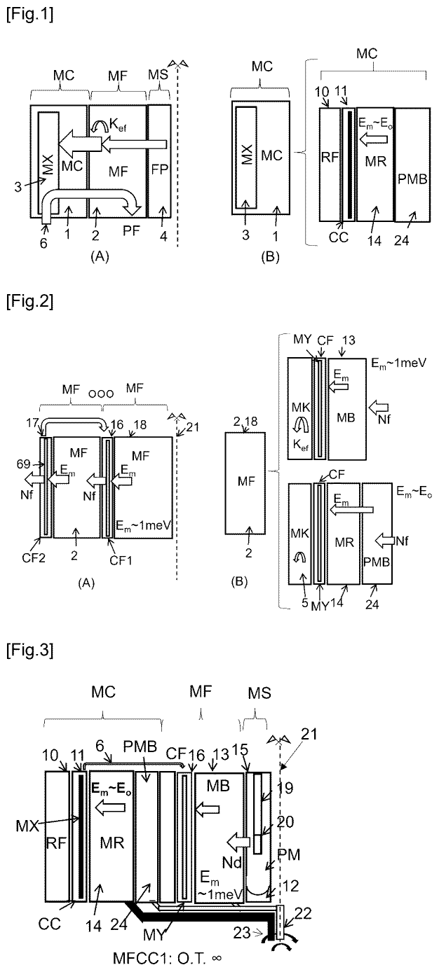

In the MCFF equipment, the following modules stand out: the MC conversion module (1), the fission module MF (2), and the source module MS (4). In this setup, the source FT (20) generates a distribution of neutrons in the MS (4) module and diffuses it to the MF (2) module to adjust the average energy of the distribution to the desired energy of the fission cross-section (XS). MF (2) promotes fission by generating fission neutrons (NF). The MF (2) module amplifies the neutron distribution and transports it to the MC module (1). MC (1) adjusts the neutron distribution energy for the conversion XS (n,γ) of fertile nuclides in the matrix MX (3) within MC (1).

[FIG. 1] (A) illustrates the arrangement {MS (4), MF (2), MC(MX) (1)} of the MFCC modules, coil MFCC1. In MFCC1, there is a neutron flux in the radial direction, while there is a mass flow (6) of nuclides in the opposite direction.

[FIG. 1] (B) illustrates the sequential components {PMB (24), MR (14), CC (MX) (11), and RF (10)} that compose the MC (1) module. Neutrons move from PMB (24) to MR (14) and after to CC (11), reaching MX (3) contained within the CC chamber (11).

The material matrix MX (3), internal to CC (11), is exclusively composed of fertile elements, in which, when exposed to neutrons in a selective spectrum, undergo the conversion of fertile nuclides into fissile ones.

In detail, MC (1) is the conversion module consisting of the following components: a low-energy dynamic pre-moderator-PMB (24), a dynamic modulator known as the resonance modulator-MR (14), a conversion chamber-CC (11) internally containing a matrix of fertile nuclides (MX) (3), followed at the periphery by a neutron reflector-RF (10).

In turn, the multiplicative fission module-MF (2) can appear as a single unit or in repetition in multiple units (13 and/or 18). MF is composed of the following components: static pre-moderator-MK (5), fission chamber-CF (16), followed by one of the options: low-energy modulator-MB (13), or the pair PMB (24) and MR (14).

[FIG. 2] (A) illustrates the possibilities of repetition of MF (2, 18), including multiple CF chambers, CF1 (16) and CF2 (17).

[FIG. 2] (B) illustrates the two options for MF (2) composition, holding {MK (5), CF (16)} followed by {MB (13)} or {MR (14), PMB (24)}, to address distinct energy spectra of the cross-section XS.

MB (27) generates a neutron distribution with an average energy Eₘ on the range of cold neutrons of 0 up to 25 meV, represented here as close to 1 meV. Meanwhile, the pair {MR (14), PMB (24)} generates a neutron distribution with an average energy Eₘ close to the resonance energy Eₒ present in the cross-section XS of the fissile nuclide (Eₘ~Eₒ). The choice depends on which region of the energy spectrum of the fission's XS of the fissile nuclide in CFs will be prioritized, that is, cold neutron energy or resonance energy.

MK (5) is a static moderator, which, in contact with the fission chamber CF (16 or 17) filled with fissile elements, forms a set {moderator-fissile nuclides} pair that aids in increasing the fission rate while keeping a multiplication factor k_{ef}.

MFCC maintains a triad of neutronic reaction and transport starting with the module MS (4) of ion-nucleon reactions with pulsed neutron emission; fissile reactions in CF (16 or 17) with multiplication in MK (5)/CF (16,17) within MF (2); followed by conversion reactions of fertile nuclides in MC (1) module.

In the pulsed neutron emission module MS (4), the source (20) generates neutrons which diffuse in a pre-moderator PM (15), and radially drive toward MF (13 and/or 18).

It states that in static moderators, fast neutrons undergo passive diffusion with a predominance of downscattering, reaching thermalization. On the other hand, when moderation occurs within dynamic materials, i.e., nuclei moving at high radial velocities, the authors define the possibility of an active diffusion, where neutrons can undergo rapid downscattering and prolonged upscattering predominantly, adjusting the neutron velocity to the speed of the medium's nuclei and being transported to the periphery of the moderator. Thus, the pair of variables radium R and angular velocity wₙ can define the terminal velocity of the neutron, and consequently, the energy of interest since E is proportional to (wₙ·R)².

In MF (2), the neutron energies adjust to the desired levels for nuclear fission in CF (16 or 17). This allows them to hold energy on the cold neutron range using the low-energy modulator MB (13) or on the fission resonance energies by PMB (24) and MR (14).

In MF (2) and (18), neutrons undergo fission within the fission chambers CF1 (16) and CF2 (17), generating neutrons in the fission spectrum. In CFs (16, 17), these neutrons are multiplied due to the presence of fissile nuclides and the static moderator MK (5). Because of the reduced thickness of MK (5), neutrons escape radially towards the periphery. In CFs, fission reactions produce heat Q and fission products (PF).

Therefore, neutrons from the source FT move radially from FT to MF, multiplied in the MK (5)-CF (16 or 17) system, and then transported to the periphery in MC (1). It is important to emphasize that the radial transport is not due to passive diffusion but rather active, helped by the rotation of the modulators MB (13), MR (14), and PMB (24) present in the MFCC system.

In the reverse direction, from the periphery to the central axis (21), there is mass transport (6) between the CC (11) and CF (16, 17) chambers, directed from MC (1) to MF (2), carrying converted fertile elements (Y) in CC (11) to the fission site CF (16, 17). A fluid, referred to as the collecting fluid Fd (6), passes through MC (1) removing the converted fissile elements in MX (3) and transporting them from the CC (11) chamber to the fission chamber CF (16) in the fission module MF (2).

The arrangement of MC (1) and MF (2) can be diverse. Thus, MCFF presents these modules in one of the following groupings: MC (1) and MF (2) as dependent modules forming a single unit {MC (1), MF (2), MS (4)} coil MCFF1 arrangement, and as independent modules {MC (1), MS (4)} and {MF (2), MS (4)} forming two units namely MCFF2 arrangement; and operating continuously over time.

FIG. 3 illustrates the arrangement MFCC1, with {MC (1), MF (2), MS (4)}, where the components keep the same central axial axis (21), placed in series, forming a single unit.

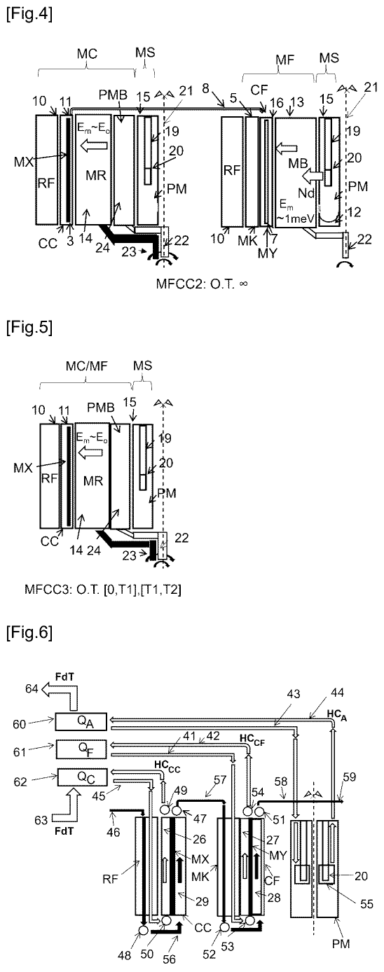

FIG. 4 illustrates MFCC2 consisting of the part pair {MC (1), MS (4)} and {MF (2), MS (4)}, forming two separate independent units. The first unit generates fissile Y nuclides by conversion of X fertile elements by XS (n, γ). The second unit is a burning unit that burns by fission reaction in CF fissile Y nuclides by fission reaction Y (n,f).

FIG. 5 illustrates a special condition for MFCC3. In this case, MFCC3 can also exist as a single unit M, which runs as MC (1) for a certain period T1 and subsequently as MF (2) for a subsequent period T2. Such arrangement is coil MFCC3. This arrangement can also burn any type of nuclides by other reactions such as (n,α), (n,p), or (n,d) reactions that have high absorption XS (n,nucleon) with 1/v behavior at low energy in cold neutron spectra.

Therefore, there are three arrangements MFCC1, MFCC2 and MFCC3, in according to the distribution of MC, MF and MS modules. If not specified, description of MFCC applies to all three arrangements.

MFCC holds a conversion chamber—CC (11). An array MX (3) of fertile nuclei is internal to CC (11). The material of MX (3) consists of solid natural Th or non-enrichment U fertile X elements, in metal, XC2 carbide, or XO2 oxide chemical shape, non-limiting.

The CF1 or CF2 (16, 17) fission chambers run fission reactions (n,f) in fissile solute Y nuclides in collecting fluid (6). There is a compartment (28) in CF (16,17) to receive such Y fissile nuclides coming from CC (11). Within CFs, there is also a MY (77) matrix of fissile material. Thus, R (n,f) reactions can occur in Y in solute and in MY (77) solid matrix. The MY (77) helps start the operation of the MFCC, in the time that the suitable concentration of Y solute is not achievable due to the lack of equilibrium of the nuclide concentrations.

MFCC may have only one fission chamber CF1 (16) or multiple chambers, CF1 and CF2 (16 and 17), through repetitions of {CF, MF (2)}, where MF (2) may hold {MB (13)} or the pair {MR (14), PMB (24)}.

MS (4) holds a pulsed source (20), a static pre-moderator PM (15), and the neutron reflector (10).

The modulator MR (14) holds magnetic connection to the rotor of a second electric motor through the shaft (23), while the other low-speed halos MB (13) and PMB (24) are directly connected to the shaft (23) and the rotor of motor (66).

PMB (24) and MB (13) run by reducing the velocity of neutrons to low energies, preferably through the downscattering process in MB (13) and PMB (24). Both are rotating at low angular speeds, ~10⁵ rpm, which can be adjusted. MB (13) runs by reducing the neutron energy to cold energies, ~0.001 eV; while the PMB partially performs this function, supporting the average energy close to the epithermal range (~1 eV).

MFCC supports at least two distinct types of nuclear reactions. One takes place in the conversion chamber CC (11), adjusting the neutron energy to reach resonance energies in the fertile element of the internal matrix MX (3) within the CC (11) chamber. The second type of reaction occurs in the fission chamber CF1 and/or CF2 (16-17), inducing fission by cold neutrons originating from a modulator MB (13). Thus, pulsed source neutrons (20), pre-moderated (15), are cooled in MB (13) and induce fission in the target of the fission chamber CF1 (16 and 17, respectively).

The fast neutrons generated in the fission of fissile Y nuclei present in the fission chamber CF1 (16) or CF2 (17) go ahead to the moderation halo MK (5), where thermal multiplication can occur. These neutrons are then actively diffused to PMB and then to the resonant modulator MR (14), adjusting the neutron energy to the resonance energy of the cross-section (n,γ) of the fertile X nucleus. The X nuclei in MX (3) within the conversion chamber CC (11) is the target of the neutron distribution from MR (14).

In another choice, MFCC operates fission in the behavior of the fission chamber CF1 (16) at resonances in the cross-section (n,f) with fission amplification in MK (5). In this case, instead of having a modulator MB (13) after PM (15), there is also a pre-moderator PMB (24) followed by a modulator MR (14).

When fission occurs in a fission chamber CF1 (n−1), fast neutrons Nf are generated. This neutron distribution can be moderated and further its average energy adjusted to resonance energy (XS with well-defined resonance) or to thermal energies (XS with 1/v behavior at low energy). Thus, the neutrons generated in CF (n−1) feed into a second chamber, CF2 (n). This process can be repeated (n, n−1, n−2, . . . ). Due to the presence of a static moderator MK (5) near the fission chamber, multiplication of primary source neutrons (20) can occur, allowing for the determination of a multiplication factor for the n MF-module, which is characteristic of the material, geometric, and quantitative conditions of fissile and fertile materials present in MFCC.

Table 1 illustrates nuclear characteristics of nuclides (Z, N) and the processes of radiative capture and radioactive decay (β-) from Th-232 to U238, in a simplified manner. Th232 is the fertile X element, a precursor to the multiplicative fission process. U238 was assumed to limit the process due to its both low (n,f) fission or (n,γ) radiative capture reactions in the spectrum of cold neutrons and low concentration generated in the fission chambers (CF). The spectrum is selective; for example, there is a significant (n,γ) cross-section of 1000 b for Eₒ of 5.5 eV of U236. However, if the spectrum is limited to cold neutrons ~1 meV in the CF1 and CF2 chambers, there will be minimal interaction at this U236 resonance energy.

The conversion of Th232 into MX (3) to Th233 occurs through the R (n,γ) reaction at the resonance Eₒ of 23.4 eV or 21.8 eV, with a cross section of 2750b or 1790b, respectively. The modulator MR (14) produces in its output face a representative neutron distribution equivalent to a Normal Distribution of neutrons Dₙ(Eₒ,σ) covering the energy range Eₒ±σ, with Eₘ~Eₒ. Thus, MR (14) favors the R (n,γ) conversion reaction Th232 (n, γ)Th233 at the Eₒ resonance energy. Indeed, the (n,f) fission or (n,γ) reactions in the 1/v behavior in CC turn impossible, due to the selectivity of the produced specific neutron spectrum in CC (11).

If the fertile X nuclide present in the MX (3) matrix is Th232 in CC (11), the Th232 (n, γ)Th233 conversion will occur, followed by decays and other radiative captures such as Th233(β-)Pa233, and Th233(n,γ) Th234, Th233(β-)Pa-233, among other transformations. The Pa and U nuclides are removed from the MX (3) matrix through elution, extracting by the collecting fluid Fd (6) that carries these nuclides to the fission chamber CF1 (16). The collecting fluid Fd (6) continues to transport the fissile Y nuclides from the first fission chamber CF1 (16) to later ones, when there is more than one CF chamber.

In CC (11) and CFs (16, 17), radioactive nuclides continue to undergo radioactive decay and radiative capture (n,γ) reactions. R (n,γ) and R (n,f) reactions may continue to occur in CF if exposed to cold neutrons and if the precursors have high cross-sections at cold neutrons spectrum. In this context, if the fertile X nuclide is Th232, there will be reactions like Th233 (n,γ) Th234, Th233 (β-) Pa233, Pa233 (n,γ) P-234, Pa234 (β-) U234, Pa233 (β-) U233, U233 (n,γ) U234, U234 (n, γ) U235, among others. If two CF chambers are employed, the increase of the concentration of such Y nuclides in each chamber can be assessed in the process.

The consumption of fissile elements will occur through fission by cold neutrons in the CF1 (16) and CF2 (17) chambers. In the case of Th232 in MX (3), the CF chambers will hold U233, U234, U235, Pa233, Pa234, exposed to cold neutrons originating from the modulator MB (13). Therefore, fission does not occur in just one fissile nuclide but in all the Y precursors of the fertile X element, even if they have short half-lives.

In summary, conversion processes by (n,γ) reactions occur in the resonant range in CC; and by fission in (n,f) reactions in CFs within the range of cold neutrons, respectively. This process supplies R(n,γ) resonance in CC (11) and R (n,f) in CF (16) for cold neutrons. However, it is also possible to have both R(n,γ) in CC (11) and R(n,f) in CF (16) following resonance spectra.

Table 2 identifies nuclear characteristics of nuclides X (Z, N) and the processes of radiative capture and radioactive decay (β-), from U238 to Am243, in a simplified manner. In this case, U-238 is the fertile X element in MX (3), a precursor to the multiplicative fission process. Pu242 is defined as the limiting nuclide due to its low fission cross-section (n,f) of 0.05 b and low (n,γ) cross-section of 100 b compared to other Pu, Np, and U nuclides in the spectrum of cold neutrons. There is a significant Pu242 (n,γ) cross-section of 100 b at 1 meV; however, it is ten times lower compared to the equivalent (n,γ) and (n,f) cross-sections of other Y nuclides in the process.

The time factor and residence time in the chambers can also help in limiting the (X, Z) nuclides in the fission process in CF (16). Thus, with a reduced time and a spectrum limited to cold neutrons (~1 meV), there will be reduced interaction in Pu-242, in comparison to nuclides from U238 to Am243.

The conversion of U238 into U239 occurs through the R (n,γ) reaction at the resonance Eₒ of 6.7 eV, with a cross-section of 7200 b. If MR (14) generates the distribution with Eₘ~6.7 eV, the neutrons will follow a Normal Distribution Dₙ(Eₘ, σ) in this energy range Eₒ±σ, where σ is the standard deviation of the particle distribution generated by MR (14). In this condition, cold neutrons will not be produced, thus preventing fission reactions or (n,γ) cross-sections in the 1/v behavior in CC (11).

After U238 conversion to U239, and through the transport of Y by the collecting fluid, Y is carried to CF1 (16), where the fission chamber is exposed to cold neutrons originating from the modulator MB (13). Therefore, in CF (16), processes of radiative capture and fission with significant (n,γ) and (n,f) cross-sections in the range of cold neutrons are privileged, complemented by transmutations that occur through radioactive decay. In this context, there are the decays U239 (n,γ) U240, U239 (β-) Np239, U240 (β-) Np240, Np239 (n,γ) Np240, Np-239 (β-) Pu-239, Np240 (β-) Pu240, Pu239 (n,γ) Pu240, Pu240 (n,γ) Pu241, Pu241 (n,γ) Pu242, Pu242 (n,γ) Pu243, Pu243 (β-) Am243.

In the case of two CF chambers are employed (CF1, 16, and CF2, 17), the concentration of such nuclides in each chamber can be assessed over time. The consumption of fissile Y nuclides will occur through fission by cold neutrons in CF1 (16) and/or CF2 (17), involving U-239, Np239, Np240, Pu239, Pu240, Pu241, among others.

In addition, MFCC presents the following main components: support's structure (68, 69, 70); peripheral static reflector RF (10); central axis (21); solid cylindrical halos. Those halos are, namely static pre-moderator PM (15); dynamic modulators PMB (24), MB (13), and MR (14), with MR (14) suspended by magnetic edge rings (75, 76). Also, MFCC has conversion chamber CC (11) having matrix MX (3), fissile chambers CFs (16, 17), holding fissile Y nuclides in solution, and may also have Y into a solid matrix MY (77).

The concentric cylindrical halos (5, 10, 13, 14, 15, 18, 24) set around the central axis (21), alternating between the chambers CC (11) and CFs (16, 17). MF (2) is just one rotating solid ring MB (13), or the rotating concentric rings PMB (24) and MR (14), always placed in sequence with CF (16) and MK (5).

Each dynamic cylindrical halo allows a nominal angular rotation wₙ, whose rotation axes (22 and 23) are in the axial direction, accommodating arbitrary angular velocities. The dynamic modulators and pre-modulators interconnect with the electromechanical system, positioned at the bottom.

PM (15) and MK (5) are static. On the other hand, the halos for PMB (24) and MB (13) run at low speed and do not require levitation. The MR halo (14) runs at medium and high angular velocity, and magnetic levitation is of interest to reduce friction.

The static Pre-Moderator (PM) (15) houses the pulsed neutron source (20). PM (15) produces partial thermal moderation of the neutrons limited passive diffusion of the neutron up to the external RPM radius of PM. Pre-moderation alters the fast spectrum of fission neutron emission, such as Watts or Maxwell-Boltzmann (~keV to MeV) at high energies, to a sub-thermalized spectrum, with partially isotropic diffuse angular orientation escaping at the periphery of the PM (15) cylinder.

The static Pre-Moderator PM (15) keeps a radial axial hole (19), with neutron sources FP (20)-inserted internally, positioned at half of the MFCC axial height.

The static Pre-Moderator PM (15) is securely attached to the upper part of the top support's structure. At the lower end of the cylinder, there is a protrusion along the edges, forming a chamber for coolant liquid (12). This capsule (12) is used to aid in lateral cooling, especially if a modulator MB (13) is used.

PM (15) is made of low-Z material (H, D, F, C, O); however, with an insufficient RPM radius to fully moderate neutrons to thermal energies. Therefore, it is said that the neutrons are pre-moderated as they are transported to the internal surface of the MF module (13), which will adjust the average of the energies of the neutron distribution through dynamic diffusion to the required energy level.

The static moderator MK (5) partially thermalizes the neutrons generated in fission within CF, contributing to the multiplication factor k_{ef}. MK (5) is a static cylindrical halo made of moderator material composed of light elements such as H, D, C, and Be. In MK (5), downscattering of fast fission neutrons occurs preferentially.

The Low-Speed Dynamic Pre-Modulator (PMB) (24) moderates fast neutrons to epithermal energies (~1 eV), preferably through downscattering, reducing the fast neutron energies. PMB initiates the process of modulating the angular direction of neutrons. PMB (24) is made of low-Z elements, such as H, C, D, F, Be. This pre-modulator is rotating and keeps an angular velocity wₙ equal to or close to the modulator MB (13).

PMB (24) can introduce additional pre-moderation at the entrance of the modulator MR (14), favoring a radial R and wₙ reduction in the design of MR (14). It is of interest to generate a neutron distribution at the entrance of modulator MR (14) with an average energy Eₘ lower than the resonance energy Eₒ so that the energy evolves radially, since MR (14) runs preferably in upscattering. In the case of PMB (24) preceding MR (14), the pre-modulator PMB (24) runs at wₙ and radius R_{PMB} such that the average output energy is close to 0.1 to 1 eV, depending on the resonant energy Eₒ to be addressed.

The low-energy modulator (MB) (13) is a dynamic cylindrical halo with low rotation capable of receiving, at the internal interface, a spectrum of diffuse isotropic neutrons in a Maxwell-Boltzmann spectrum, close to thermal energies (~eV) at the output of PM (15) and adjusting the neutron spectrum to very low energies at cold neutron domain (~1 meV) at the external interface of MB. This is the design energy for MB (13), although MB can run at lower energies if needed.

MB (13) is typically made with low-Z elements of minimal radiative absorption cross-section (XS) and high scattering XS to ease rapid downscattering, preferably. The common material for MB (13) includes F, C, D, Be, and O, among others.

The Resonant Modulator (MR) (14) is a dynamic cylindrical halo with high rotation (>10⁵ rpm), maintained in magnetic suspension, capable of receiving at the internal interface a neutron spectrum oriented radially at low energies (~0.02-1.0 eV) from the output of the pre-modulator PMB (24) and adjusting the spectrum to Dₙ(Eₘ, σ), with Eₘ close to the resonant energy Eₒ for the relevant cross-section (XS) in question, where Eₒ is 23.4 eV or 21.8 eV for Th232, or 6.5 eV for U238 (non-limiting to serving fertile Y nuclide resonances), at the external interface of MR (14).

MR (14) is made with intermediate Z-elements (C, F, Be, Zr, non-limiting). At the external R_{MR} radius, MR (14) supplies an output of neutrons in a beam oriented radially.

In summary, MR (14) adjusts Dₙ(Eₘ, σ) at the resonance energy by conforming to a normal distribution and tunneling Eₘ at the resonance energy Eₒ.

The peripheral reflector RF (10) is found at the outer part, made of a static concentric halo coupled to the lateral support structure (69). Such a reflector consists of high elastic scattering cross-section material, with high Z to avoid energy losses in elastic collisions, and very low neutron absorption cross-section in the spectrum adopted for the target internalized in the conversion chamber CC (11). When the chosen material can also supply moderation to thermal energies, Boron is added to the outer peripheral layer of the reflector to remove any thermal neutrons that may escape. This protection can also exist at the base and the top of each pre-modulator PMB (24), MK (5), MB (13), and PM (15).

The pulsed neutron source (20) is at the center of the pre-moderator halo (15), inserted through the halo perforation (19). The neutron source (FP) can generate neutrons through D-D or D-T fusion reactions, where the incident D positive or negative ions come from a deuterium accelerator (9) and guided (19) to TiD or TiT targets (20) to produce D(d,n) or D(t,n) reactions. Alternatively, the source can produce neutrons through (p,n) reactions using a H negative or positive ion accelerator with energy above the threshold for bombarding light chemical element targets such as Li, Be, or B, positioned in (20). The ratio of neutron per ion collided on the target depends on distinct factors, such as type of reactions p(Li,n), d(D,n), d(T,n) and their cross sections, target-nuclide atomic concentration on target, vacuum condition, ion kinetic energy. Indeed, the ratio varies from 1.10⁻⁶ to 5.10⁻⁴ neutrons emission per ion injected.

The accelerator injects ions into the guide cylindrical hollow (19), reaching their target (20). Neutrons generation occurs with distinct spectra, specific to each nucleon-nucleon reaction and kinetic energy of the incident ions (H⁻, H⁺, α⁺, D⁺, D⁻), with energies above the threshold for nuclear reactions.

Such sources (20), as well as the ion accelerators (9), are technologies in the public domain and widely known in the academic and industrial fields and will not be described in this document.

The HC_{A} circulation of a coolant fluid whose circuit (43, 44, 55) is internally accommodated within the static cylinder PM (15). HC_{A} cools the target (20) impregnated with T, D, Li, Be, or B, recovering the heat after transferring it to a FdT working fluid.

To further clarify the connection of the axes (22, 23) of the electromechanical system with the rotating cylindric halos (13, 14, 24), it is reported that, in the case of low and medium speed rotating cylindrical halos (13, 24), these can be directly connected to the rotor of a motor (65).

When there are multiple rotating cylindric halos with different nominal angular velocities wₙ, it is possible to include an electromechanical system having hollow-shaft motors (65, 66) with permanent magnet rotors and stators with coils. Additionally, variations in angular velocity can be achieved through interconnected gears. This gear technology is known, and detailed connections of the shafts to the modulators 13, 24, and 14 will not be shown.

The connection of high angular velocity rotating modulators (14) with the motors can be achieved through magnetic interaction, ensuring that there is no mechanical contact and friction between the modulators and their rotating mechanical parts (23). Magnetic bearings are used on the motor shafts (not illustrated).

Such technologies are well-known and widely spread, and specific technical details of this connection are not required.

There are four concentric magnetic rings (74, 75) arranged in pairs, one set on the top and one on the bottom. The magnets are fixed at the top and base of the modulator MR (14), and the other set of magnets with the same polarity is fixed to the upper and lower structure of the MFCC. Repulsion is allowed both at the top and bottom, using the same N-N and S-S poles. At the top part of the support structure (68), there are metal rings with perforations for positioning magnetic pressure adjustment devices. This adjustment allows the vertical positioning of the rotating ring. The asymmetry in the adjustment enables axial and radial adjustment of the modulator MR (14) in levitation.

The CC component (11) consists of concentric cylindric halo, fixed to the lateral structure of the device (69). CC (11) internally contains a solid matrix MX (3), composed of fertile elements, denoted as X(N,Z), which will be converted through radiative capture into fissile material Y(N,Z). CC (11) can be composed of multiple angular sectors.

In another aspect, a fluid can axially flow on the inner radial side (29) through the internal face of fertile matrix MX (3). The fissile Y nuclide becomes dissociated from the matrix and can be removed by the collecting fluid solution. The solution has a reduced absorption cross-section in the spectrum to which CC (11) is exposed.

There are two types of chambers: the conversion chamber CC (11), positioned fixed internally to the reflector ring RF (10); and fission chambers CF1 (16), or additionally CF2 (17).

Each fission chamber CF (16, 17) is followed radially towards the periphery by a static concentric ring MK (5), and it is preceded radially by MB (13). The components MK (5), CF (16), and MB (13) form the fission module MF (2).

The conversion chamber CC (11) and the CF chambers (16, 17), as well as the static moderators MK (5) and reflector RF (10), can be divided into angular sectors, allowing them to be disassembled and removed without the need to dismantle the entire circuit; or separately sealed as needed for radiological safety.

The CC (11) and CF (16) chambers hold internally and radially two compartments each, with CC having compartments 26 and 29, and CF having compartments 27 and 28. The peripheral compartments 26 of CC and 27 of CF are used for heat removal through an ascending axial flow of a coolant fluid.

The innermost compartments, 29 in CC and 28 in CF, hold the transport of the converted fissile nuclides through a fluid flow known as the collection flow (6). The collection flow (6) moves in the inner compartment 29 of CC in an ascending axial direction, removing converted fissile nuclides from MX (3), and transports them to the compartment 28 of CF (16, 17) following an ascending axial flow, where fission can occur.

The thicknesses of the compartments in CC and CF are different, depending on the residence time of the collection flow. For example, the thickness of CC may be ⅕ of the thickness of CF.

In the internal chambers 28 and 29, on the radial peripheral face, there are solid matrices MX (3) and MY (77) respectively, separating the compartments of the CC (11) and CF (16,17) chambers. MX (3) is composed of fertile elements X. MY holds fissile elements Y.

To provide a clearer understanding of the equipment embodiment, a design for MFCC is presented, detailing the transportation of HC coolant fluids and the Fd collection flow in its Cc circuit. The complexity of the number of connections in the HC and Cc fluid circuits will depend on the number of divided angular sectors of the CC (11) and of the CFs (16, 17) chambers.

FIG. 6 illustrates the HC (31, 32, 33) coolant fluid transports from the heat-generating sources to the heat exchangers.

The HC_{A} (33) circuit holds circulating coolant fluid removing the QA heat generated in the target (20) due to ion bombardment. HC_{A} has pipes (43) and (44) linked to the cooling capsule (55), internal to PM, and transferring QA to the heat exchanger (60).

The heat Q_{F} generated in the CF fission chamber flows through pipes (41) and (42) and transported to the heat exchanger (61). This cooling circuit is coil HC_{CF}. There is a HC_{CF} (32) to each Cfi included on MFCC.

In turn, the withdrawal of the heat generated in the conversion of fertile nuclides Qc is from the CC chamber (11) and transported through pipes (45) and (46) to the heat exchanger (62). This cooling circuit is namely HC_{CC} (31). There is HC_{A}, HC_{CC}, HC_{CF} for the MFCC1 and MFCC2 arrangement. There is only one HC_{C} to MFCC3 arrangement.

The HCs coolant fluid circuits are fully independents. Additionally, a FdT working fluid circulates from (63) to (64), removing and transferring the total heat to a turbine or for heating purposes.

RF (10) and MK (5) are static halos that allow axial pipes to transfer the fluid from the top of the heat exchanger (HEs) to the base of the CC (11) and CF (16) chambers. The coolant fluid circulates from the base to the top in the cooling compartments 26 and 27 of CC (11) and CF (16), respectively. The same applies to PM (15). The fluids flow at the base rings (50) in CC, (53) in CF, and at the top rings (49) in CC, (54) in CF (16).

The coolant fluids in HCs can circulate preferably through natural convection by selecting pipe diameters and the height of the heat-generating source, the height of the heat exchangers, and evaluating the variation of density with the fluid's temperature. However, pumps for forced circulation can be included in-line in each circuit, not shown in the figures.

FIG. 6 also illustrates the transport of the collecting fluid Fd in the Cc circuit (46, 48, 56, 47, 57, 52, 51, 58, 59). This fluid collects the converted Y nuclides in the CC chamber (11), extracting them by elution from the MX matrix (3). It is known that nuclear reactions generate byproducts with kinetic energies thousands of times higher than the chemical bonds of the fertile elements present in the MX matrix (3). Therefore, the converted Y elements are expelled from the matrix of fertile X elements in random directions through various nuclear transformations, and many Y elements can be removed by elution.

FIG. 6 shows that the collecting fluid Fd in the C_{C} circuit enters at (46) and cross axial the RF (10) until the base ring (48). From there, Fd flows in the axial direction in the compartment (29) where MX (3) is present, collecting the converted Y nuclides and transporting them to the top ring (47). Thus, the circulation of the fluid Fd occurs radially through (57) tubes from (47) ring on CC (11) top toward CF (16) down in MK (5) to the bottom ring (52). From there, Fd flows axially in the inner compartment (28) in CF (16). The transport can be by natural convection or oriented by a pump in line.

The fluid Fd of the C_{C} circuit, carrying the fissile Y nuclides, exposes these elements in the inner compartment (28) to the neutron distribution Dₙ that reaches CF (16). Thus, fission will occur, generating fission products PF in Fd. Then, the contaminant collecting fluid FdC transports PF and Y nuclides from the base ring (52) of CF (16) to the top ring (54). From there, FdC flows through pipe 58 to outlet 59. The fluid FdC with the fission products residues and non-reacted Y fissile elements flows to the chemical processing (CPM) (39).

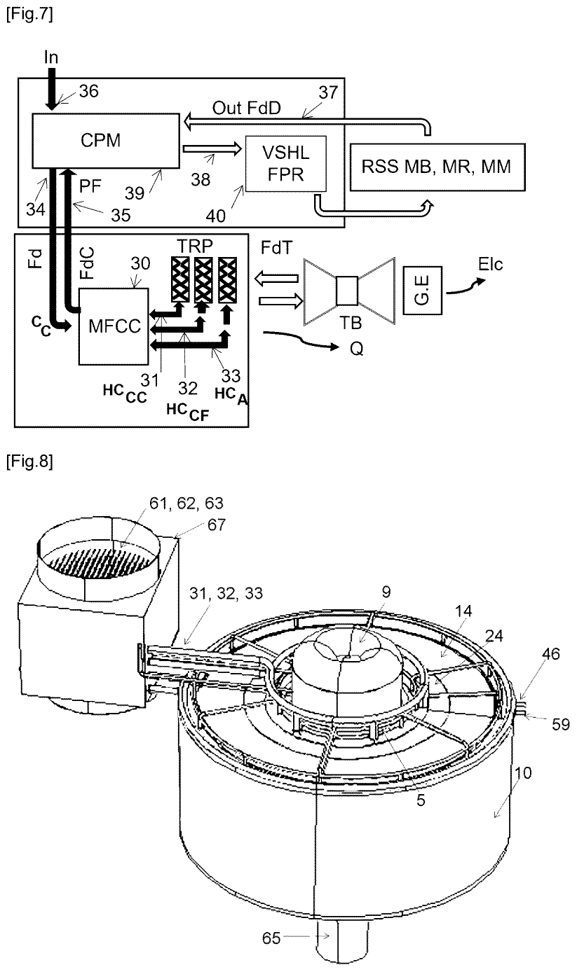

FIG. 7 presents a diagram of the Cc circuit of the Fd (34) collecting fluid for MFCC (30), followed by the outlet of the FdC (35) contaminated fluid towards the chemical processing module CPM (39). In CPM, a reservoir (FPR) (40) stores the PF contaminants (38) for a sufficient period to reduce the activity of radionuclides with short half-lives. From 40, FdC is transported to the RSS units MB, MR, and MM, which decontaminate the fission products. RSS is described elsewhere (sent patent PCT/BR2023/050225, Date of Receipt: 1 Jul. 2023, Receiving Office: National Institute of Industrial Property (Brazil)). The FdD decontaminated fluid returns (37) to CPM (39). CPM adds fresh fluid (36) and returns Fd to MFCC.

FIG. 7 illustrates the recirculation of the coolant fluid at the HC circuits (31, 32, 33) between the heat-generating sources in MFCC and their respective HE heats exchangers. The working fluid FdT transfers the whole QT heat to a mechanical turbine, generating mechanical work and electrical power. Alternatively, the QT heat is directly used for industrial or residential heating purposes.

FIG. 8 shows an embodiment of MFCC1. It depicts the heat exchanger box (67) where the working fluid FdT moves through HE (61, 62, 63) heat exchanger. The position of the ion accelerators (9) that accelerate and direct ions (19) toward the target (20) is visible. The components MK (5), RF (10), PMB (24), MR (14), the outlets (59), and the inlet (46) for the fresh Fd and (59) outlet for the contaminated FdC fluids, as well as motors (65, 66) at the bottom connected to the central axis (21), can also be identified.

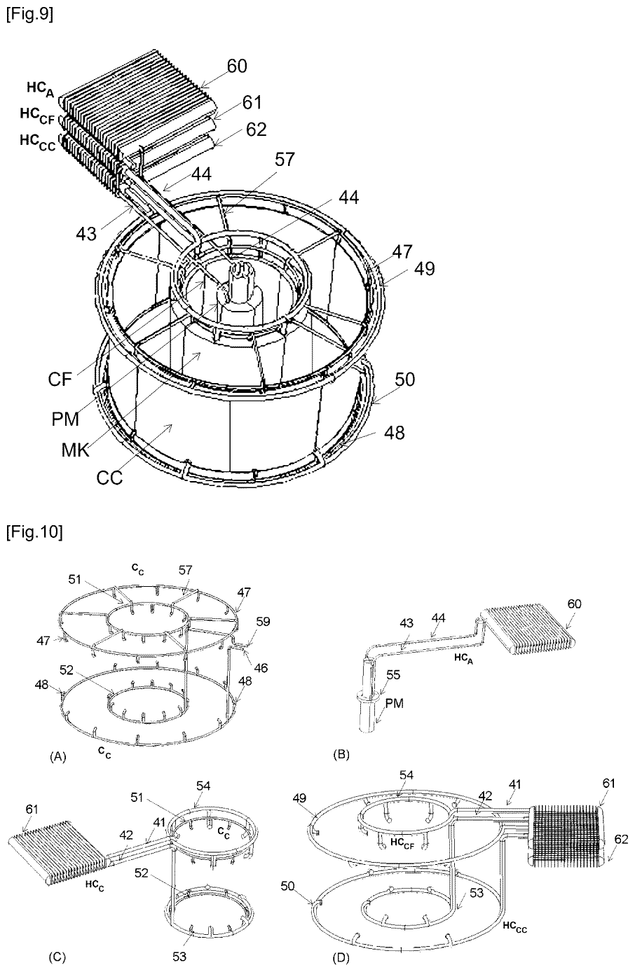

FIG. 9 illustrates the HC cooling fluid circulation systems of the MFCC1. There are three cooling systems: one HC_{A} for the accelerator target, another HC_{CF} for the CF chamber, and the third HC_{CC} for the CC chamber. The heat exchangers 61, 62, and 63 are used for these respective cooling systems to remove the heat and transfer it to FdT working fluid.

FIG. 9 shows the circulation rings at the peripheral (47, 49) and internal (54, 51) ones on top. Additionally, the rings at the peripheral (48 and 50) and internal (52, 53) ones on base are also found. The interconnection between the upper peripheral and internal rings of the Cc collecting fluid circuit is named by 57 tubes. The CC (11) and CF (16) chambers, as well as the static moderators MK (5) and PM (15), are visible.

In summary, there are the HC circulation systems for the cooling fluids and the Cc circuit for Fd and FdC fluids. Additionally, the FdC fluid is further cooled outside the MFCC in the chemical processing module (CPM) and in the radioactive waste treatment system RSS (submitted patent PCT/BR2023/050225, Date of Receipt: 1 Jul. 2023, Receiving Office: National Institute of Industrial Property (Brazil)). The chemical processing and decontamination system for the fission products are not within the scope of this patent application.

FIG. 10 details separately the HC cooling and Cc collection fluid circuits. In (A), the Cc collection circuit for MFCC1 is identified with the upper 51 (internal) and 47 (peripheral) rings; lower 52 (internal) and 48 (peripheral) rings; interconnection 57 between upper peripheral and internal rings; and the (46) inlet and (47) outlet of Fd and FdC fluids, respectively.

[FIG. 10] (B) details the HC_{A} cooling circuit for the accelerator target showing the pipes 43 and 44, the heat exchanger 60, the cooling cylinder halo box 55, and the moderator PM (15). HC_{A} is presented in MFCC1, 2 and 3 arrangements.

[FIG. 10 [(C) illustrates the HC and C_{C} circuits for independent units in MFCC2 and MFCC3. On these arrangements, there are double sets of peripheral and internal rings. On MFCC3, only one set of rings (51,53, 52, 53) is present.

[FIG. 10] (D) depicts the two independent HC_{CC} and HC_{CF} cooling circuits for the CC (11) (peripheral) and CF (16) (internal) chambers. The pipes 41 and 42 connected to the CF (16) heat exchanger 61 can be seen; the top peripheral rings 49 and 50 of CC (11); the top internal rings 54 and base 53 of CF (16); and the heat exchanger 62 for CC (11).

The instrumentation is on hallow rods inside the RF reflector (10), facing the external surface of CC (11); and inside the moderator MK (5), facing the surface of CF (16, 17).

Among the instruments are gamma radiation meter, neutron meter, temperature meter, pressure meter, and PH meter for the Fc and FcC fluids. The measurements are taken in the compartments of CC (11) and CF (16) chambers. The figures did not show such pointwise meters.

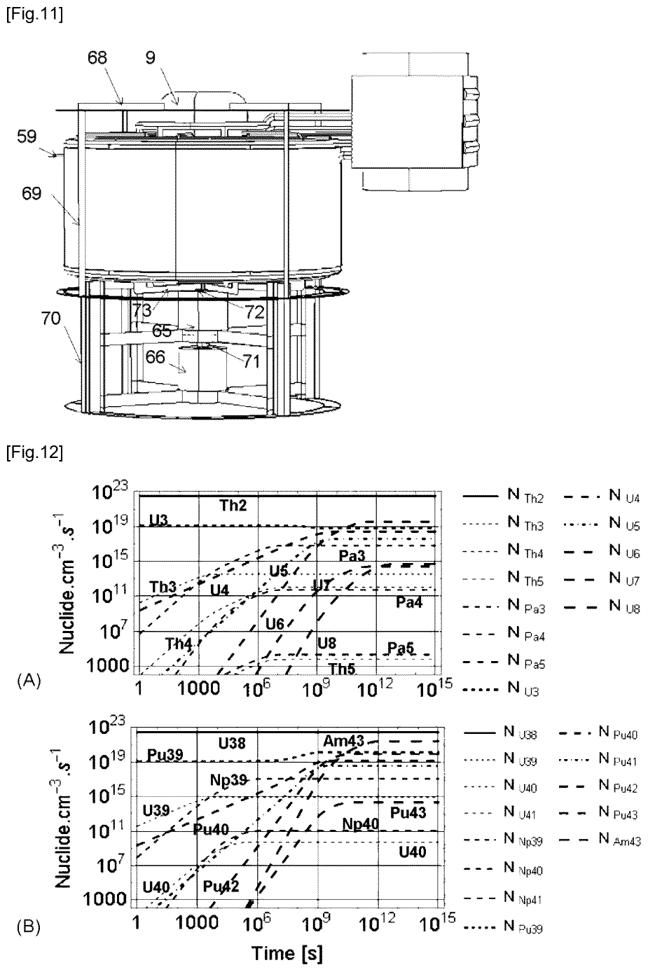

FIG. 11 illustrates the support structure (68, 69, 70), made of metal, steel, or aluminum. The structure consists of fixings for positioning the rotary motors at the base (65, 66), whose shafts are secured by magnetic bearings at the lower position. The rotor shaft is in the center of metallic fins (72). On top of the fins, a circular metal base exists, and on it, the rotary modulator type MR (14), MB (13), or PMB (24) attaches. In the structure, both at the top and bottom, there are metal supports where the set of magnetic rings are held. The coupling of the base with the modulator MR (14) will be magnetic without physical contact due to high rotational speeds (~>10⁵ rpm); however, the fins may make contact in MB and PMB under low rotational speeds condition (~<10⁵ rpm).

The operation and geometric definitions, as well as the materials used in the permanent magnet motors (65, 66), which are connected by their shafts to the modulators MB (13), MR (14), or PMB (24), with or without gears, with or without magnetic coupling, are well-known technologies and are based on academic and technological knowledge already widely disseminated, being in the public domain. Therefore, they do not need specific or descriptive details. Simply sign of the existence of these motors, shafts, and their positions is sufficient for technological implementation. Variations in the electrical and mechanical characteristics of these motors, dimensions, power, and shaft coupling are possible without standing for advances in the technology specified in this patent.

Since MFCC operates with radiative capture and fission reactions, these reactions produce X-rays and gamma-rays' emissions that need to be shielded and removed from the environment. However, internal gamma ray shielding was not included in MFCC. As this equipment can be coupled together, the decision was made to place the gamma ray shielding in a static geometry, external to the equipment, in the environment where it will be run.

The radiological protection in external environments will not be described in this document, and the design of such protection is not part of the scope of this document.

The collecting fluid Fd and cooling fluid can run in high pressure to support elevated temperature. Also, both fluids should be immiscible to reduce the possibility of contaminant's transferences, as water and oil. The solution of Y fissile elements in Fd can occur using chelate substances and nanoparticles to increase the collecting ability of Fd. There are no restrictions to the material used as Fd and cooling fluids since the choice will depend on the desirable temperature, pressure, and power generation for the operation of the MFCC system.

The system starts with a first loading of fissile elements in the fissile chambers, and later reaches stability through the conversion of fertile Th232 or U238 into fissile material. A solid matrix MY (77) may be included in inner compartment (28) of CF (16), like MX (3) in CC (11). The MY (77) matrix, in addition to the Y fissile nuclides in Fd collecting fluid (6) solution flowing in compartment (28) of CF (16), holds fissile elements. The Y elements in Fd collecting fluid grow in time up to the equilibrium concentration conditions. Both fissile elements maintain subcriticality in the {MK (5), CF (16)} assembly with k_{ef} close to 0.95.

At the beginning of operation, when the concentrations of fissile Y nuclides in the collecting fluid Fd (6) are low, an added mass of fissile elements Y can be diluted in the collecting fluid. Both methods, MY (77) and Y diluted in Fd (6), can be used for the initialization of the operation.

During operation, as the fertile elements are converted into MX (3), the concentrations of the nuclides originating from the fertile X element increase until reaching stability. From then on, the system runs at constant thermal power.

A balance of nuclide concentrations in the collecting fluid Fd (6) can be obtained by solving the balance for losses of the precursor X (N, Z) through: i) radiative capture (N, Z)→(N+1, Z), ii) beta decay (β-), and iii) losses through fission (n,f) PF; and, the gain of concentration of the generated nuclides (N+1, Z) through radiative capture (n,γ). The balances of gains and losses, based on neutron fluxes in their respective spectra in the spatial, radial groups, as well as the flows of fluids of diluents of fertile and fissile nuclides, residence time in each chamber, define the dynamic process of “conversion” and “multiplicative fission of MFCC.

The operation of MFCC will consume fertile X elements in MX (3) and reduce the concentration of fissile elements in MY (77), so decreasing the multiplication capacity by reducing the adopted subcriticality factor (e.g., ~0.95). However, there will be compensations from the increased concentrations of fissile Y elements in CF (16) resulting from the conversion of fertile X elements into fissile ones in CC (11).

The presented analysis on this document was supported by data obtained to show the collective behavior of particles inside the dynamic pre-moderators and modulators. These simulations employed nuclear data (nuclear libraries: ENDFB-V/VIII.0, JEFF-3.3, EAF-2000, TENDL-2019, citation list) and stochastic nuclear codes MCNP6 (Durkee, J. W. et al., MCNP6 moving objects Part I: Theory; Part II, Prog. Nucl. Energy, 2016). In the computational analysis, subroutines developed by the authors were coupled, considering probability and statistical evaluations, as well as physical phenomena of nuclear scattering and absorption interactions that occur within the MFCC. Three-dimensional collisions of two bodies with different masses, initial velocities, and angular velocities were analyzed. Multigroup treatment was considered, with spatial and energy group discretization.

The analysis also considered thermal vibration and temperature variations of the medium. The physics and mathematics involved in the modeling are complex but are within the academic knowledge and public domain, widely issued in specialized literature in the nuclear field, as showed, among other sources, in Harrisson G. et al, Nuclear Inst. Meth. In Physics Research, Section A., Vol. 959, 2020.

The subject matter can be better understood through the following examples, which are not exhaustive.

### EXAMPLES

### Example 1

Tables 3 and 4 illustrate material and geometrical characteristics of MFCC, in a non-limiting manner. Note that the geometry and angular velocity of the MR modulator can be chosen according to the type of fertile nuclide in the internal matrix in the CC chamber, with Th-232 requiring a transmutation (n, Y) in the energy of E≈22 eV, while for U238, the energy is ~ 6.5 eV.

### Example 2

This example addresses the nuclide concentrations in Th232-U238 cycle. A MFCC model was considered with the following geometric data: CP and CF chamber thicknesses of L_{CP} 1.5 cm and L_{CF} 1.5 cm, respectively; L_{PM} of 7.5 cm; L_{MK} of 6 cm; L_{MB} of 12 cm; L_{PMB} of 8 cm; L_{MR} of 100 cm; two CFi chambers (i=1,2), with CF1 radius equal to (L_{PM}+L_{MB}) and CF2 radius equal to (L_{CF1}+L_{MB}+L_{MK}+L_{CF1}); CP radius equal to (R_{CF2}+L_{MK}+L_{PMB}+L_{MR}); L_{RF} thickness of 8 cm; and MCFF height of 70 cm. The total radius of MCFF was 161.70 cm. The area of CP was 67293 cm²; CF1 area was 8577 cm²; and CF2 area was 17153 cm². The volumes of CP, CF1, and CF2 were 100.93 liters, 12.85 liters, and 25.73 liters, respectively. The total CFₜ volume was 38.58 liters.

The chosen material for the modulators was MB (13) graphite with a rotation speed of 1.10⁵ rpm, while MR (14) was made of Zircalloy with a rotation speed of 9.10⁵ rpm. For PMB (24), the material used was polytetrafluorethylene (PTFE) PTFE-Graphite, rotating at 1000 rpm. The neutron transmission coefficients in the evaluated energy groups were K_{MP} 0.95, K_{MB} 0.85, K_{MR} 0.97, and K_{MPB} 0.90, considering losses due to absorption in elastic scattering. A neutron emission value of n=2.3 neutrons per fission was adopted.

The fluence reduction factors based on the area ratio were F_{CF1/CF2} of 0.25 and F_{CI2/CP} of 0.065. The multiplication factor adopted in (MK+CF1) and (MK+CF2) was evaluated using the MCNP code, with a first mass of fissile elements of 200 g (considered as an estimate of the equilibrium concentration in the CP volume in this analysis). The obtained k_{ef} value was 0.975, while keeping a matrix MY (77) UO₂ (3%) of 0.003 m in CF1 and CF2. The multiplication factor 1/(1-Kef) was estimated to be a value of 40 in both CF1 and CF2 and was arbitrarily kept constant during the operation of MCFF; however, the positive or negative variation of fissile material during operation was not considered. A variation in the concentration of the matrix MY (77) in CFs may be considered in future assessments to compensate for negative K_{ef} changes over time.

The density of Th232 in MX (3) was 11.7 g/cm³ for metallic thorium, with A=232. The atomic density of Th232 in MX (3) was 3.03×10²² atoms/cm³. In this example, the initial atomic density of fissile element U233 dissolved in the collecting fluid was 1.3×10¹⁹ atoms/cm³.

The total surgency of the distributed source in (20) was 2×10¹³ n/s. The neutron flux φ_{CF1}, evaluated by diffusion in PM (15) and subsequently modulated in MB (13), reached CF1 (16) with a value of 3.86×10⁹ n/cm²·s.

Fission reactions were evaluated for Th233, Th234, Th235, Pa233, Pa234, Pa235, U233, U234, U235, U236, U237, U238, adopting the microscopic cross-section of neutrons modulated by MB in the energy range of cold neutron arbitrary assumed as 0.001 eV on this example, with a standard deviation of 0.01 eV. Table 1 illustrates the nuclide chart in the Th232-U238 cycle and its corresponding nuclear data.

The integral of the reaction rate IRR in the energy spectrum domain of the neutron distribution Dₙ(Eₘ, σ) and the microscopic cross-section of radiative capture (n,γ) (Sᵢ, i equals g) in the resonance region with energy Eₒ is obtained by the following expression:

$$IRR = {\int }_{- 2 σ}^{2 σ} dE Si ( E ) PDF ( {D}_{n} ( {E}_{m} , , σ ) , E ) . \qquad [ Math . 1 ]$$

On the other hand, the integral of the reaction rate IRC in the spectrum domain of the neutron distribution Dₙ(Eₘ, σ) multiplied by the microscopic cross-section of radiative capture (n,γ) in the low-energy region with a 1/v behavior is given by:

$$IRC = So {\int }_{- 2 σ}^{2 σ} dE PDF ( {D}_{n} ( {E}_{m} , σ ) , E ) \cdot \sqrt{1 / E} \qquad [ Math \text{.2} ]$$

where the microscopic cross-section in the region of thermal neutrons (i=g) was represented by:

$$Si = So \sqrt{1 / E} \qquad [ Math \text{.3} ]$$

In the cold spectrum region, Eq. 3 can be used to evaluate the fission cross-section (S_{f}), where Sₒ is the cross-section at cold neutron range in XS(n,f).

The microscopic resonant cross-sections for radiative capture (i=g) and fission (i=f) in the energy domain of resonance can be represented by the Wigner equation, as follows:

$$Si = So \frac{{G}_{i}}{{G}_{T}} \sqrt{{E}_{o} / E} ( 1 + {( 2 ( E - {E}_{o} ) / {G}_{T} )}^{2} \qquad [ Math \text{.4} ]$$

In this case, Sₒ is the cross-section at the resonance energy Eₒ, given by:

$$So = g \frac{{G}_{i}}{{G}_{T}} ( 2.608 * 1 {0}^{6} / {E}_{o} ) {( ( A + 1 ) / A )}^{2} \qquad [ Math \text{.5} ]$$

The parameters G_{f}, G_{g}, G_{T}, and Eₒ are resonance parameters found in nuclear data literature (Mughabghab, S.F., Atlas of Neutron Resonances, Resonances Parameters and Thermal Cross Sections Z=1-100, 5^{th} Editon, National Nuclear Data Center, Brookhaven National Laboratory, USA, Elsevier, ISBN: 978-0-444052035-7). In a scenario where the neutron distribution follows an equivalent Normal Distribution, the evaluation of the integral can be done by considering the Probability Density Function (PDF) of the normal distribution function. Note that the PDF normalizes the distribution D(Em, s), making it equivalent to a normal distribution.

In this example, the value of the integral for cold neutrons of the fission cross-section IRC_{f} was evaluated at Eₘ at cold neutron domain (0.001 eV) and σ=0.01 eV for each of the fissile nuclides, resulting in a value of 16.85 Sₒ for fission. Additionally, the values of IRC_{g} for radiative capture in cold neutrons were also evaluated for all fissile nuclides. The value of Eₘ±σ is enclose the cold neutron domain and can achieve values of 1 up to 25 meV, depend on the MB design and temperature. Therefore, different values can be found out of this example.

The neutron flux in CF1, which reaches CF1, was evaluated by

$${ϕ}_{CF 1} = {K}_{MB} \cdot {K}_{F 1} \frac{{S}_{D D}}{2 π {R}_{C F 1}^{2}} \qquad [ Math \text{.6} ]$$

where S_{DT} or S_{DD} is the neutron emergence from the source in n/s, where D⁺ ions were accelerated and collided with a Tritium (T) or Deuterium (D) target. The neutron flux that reaches CF2 was evaluated by

$${ϕ}_{CF 2} = η {K}_{MB} \cdot {K}_{F 2} \cdot {F}_{CF} \sum ( {ϕ}_{CF 1} \cdot {IRC}_{fCF 1} ) \qquad [ Math \text{.7} ]$$

in which where φ_{CF1} and φ_{CF2} are the fluxes in the fission chambers CF1 and CF2, respectively. The factors K_{F2} are the multiplication coefficients of the pair {MK (5), CF (16, 17). On the other hand, the neutron flux that reaches CP shall be:

$${ϕ}_{CC} = η {K}_{PMB} {K}_{MR} {K}_{F 2} {F}_{CF} \sum ( {ϕ}_{CF 2} \cdot {IRC}_{f CF 2} ) \qquad [ Math \text{.8} ]$$

The resonance integral of radiative capture for Th232 at 23.4 eV or 21.8 eV was evaluated as S_{g}.IRR. The neutron fluxes in CF2 and CP were assessed to be 5.11×10¹⁰ and 4.52×10⁹ n/cm²·s, respectively.

A simplified system of 13 equations, concerning the rates of radiative capture and fission reactions, radioactive decays, and including all fertile and fissile nuclides in the Th232-U238 cycle, was evaluated as a function of time. The initial values for the atomic density of Th232 and U233 were inserted at time zero.

Table 1 illustrates the set of nuclides Th232, Th233, Th234, Th235, Pa233, Pa234, Pa235, U233, U234, U235, U236, U237, and U238, whose concentrations vary in the system of equations. The rates of elimination reactions through radiative capture (n,γ), B-decay, and fission were evaluated, as well as the production rates through (n,γ) conversion of the precursor nuclide. The interaction probabilities at 1/v in cold neutron range, as well as at resonance energies Eₒ, are presented for both (n,γ) and (n,f) reactions.

FIG. 12 illustrates the atomic densities in atoms/cm³.s of the respective nuclides as a function of time for the given geometric and material conditions. The concentrations of Th232 in the MX (3) matrix remain constant, while the concentrations of the precursor nuclides to Th232 increase over time, reaching equilibrium starting at 10⁹ seconds and stabilizing around 10¹² seconds. The density of U233, initially at 200 g in CFs, decreases starting after 10¹⁰ seconds of operation, but it is compensated by the increase in the concentration of U233 generated in the operational process of MFCC1, thus staying continuous.

### Example 3

This example addresses the Th232-U238 Cycle Heat and Energy Generation. A neutron emergence of 2×10¹³ n/s was considered, produced by bombarding TiD target with 120 keV deuterium ions at a rate of 2×10¹⁷ d/s. The energy of the generated neutrons was 2.4. The energy consumed for this current acceleration was 3.84 kWh. This energy is accumulated in the target (20) as heat and removed to the heat exchanger. A thermal transfer efficiency of 95% was considered, using a cooling fluid, multiplied by 60% of efficiency in heat recovery to FdT. Consequently, the recovered Q_{acel} was 1.83 kWh, considering Q_{DD} of 10.4 W, and Q_{DT} of 56.4 W, deposited by fusion reactions if the target holds D or T.

Table 5 presents thermal parameters and efficiency evaluations of the nuclear MFCC system running in the Th232-U238 cycle in a simplified analysis and with specific initial concentration and FT emission conditions. The thermal energy generated in CF (16) and CC (11) chambers, as well as the total thermal energy combined with Q_{acel}, is 54.17 kWh at 10⁵s and 30.28 kWh at 10¹⁴s, shown at two arbitrary times. The Brayton cycle was considered in electricity production from the transported heat, adopting a 60% efficiency in this thermodynamic cycle. The heat is transferred from the secondary fluid FdT to the turbine, which rotates the electrical generator GE. It is noteworthy that the current operation presented in the MFCC1 model estimates a generation of 32 kWₑh (kilowatt-electric-hour) in first phase (concentration non-equilibrium) and 18.17 kWₑh (concentration in equilibrium).

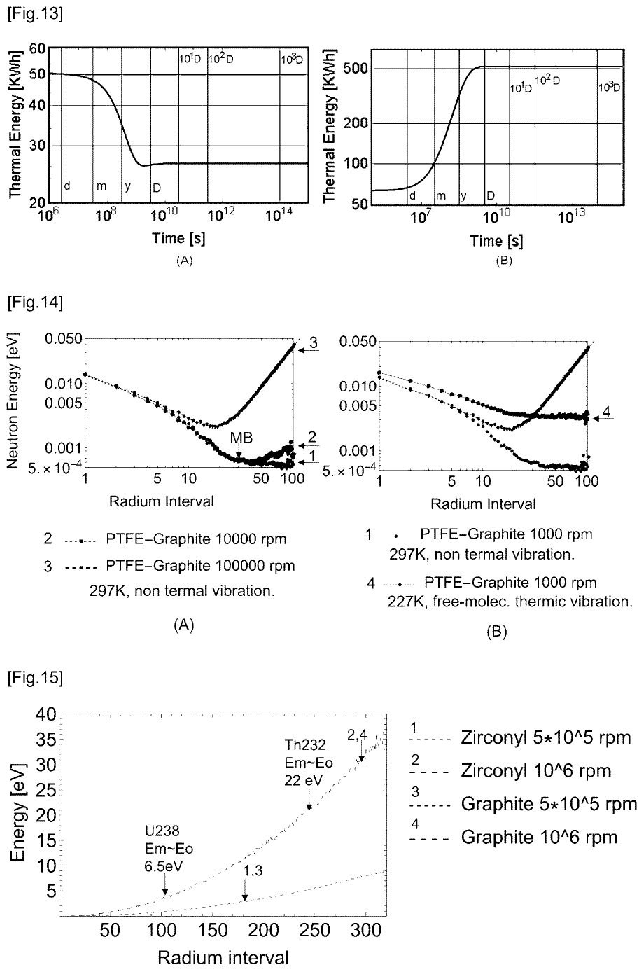

FIG. 13 illustrates the thermal energy generated during the operation time of the MFCC equipment running in the Th232-U238 cycle. In the period from 1 to 10⁸ seconds, the MFCC operates based on the initial mass of fissile nuclides, and the equilibrium of precursor nuclide concentrations of the fertile element, in this case, in the Th232-U238 cycle, is achieved. The estimated time to reach concentration stability is one year. During this period, the MFCC operates fueled by the fission of the nuclides inserted during initialization.

In the period from 10⁸ to 10¹⁰ seconds, there is a transition in which the fissile nuclides produced by conversion in the CC start to contribute to the heat generation, while the concentration of initial fissile elements reduces. This second phase of operation is relevant since it runs producing heat based on its own fission fuel.

### Example 4

This example addresses the nuclide concentration of the nuclides in U238-Am243 cycle. It applies the same source parameters in Example 3. In the U238-Am243 cycle, the MX (3) matrix consists of U238, holding 200 g of Pu239 diluted in the circulating collecting fluid (6).

Table 2 illustrates the set of nuclides U238, U239, U240, U241, Np239, Np240, Np241, Pu239, Pu240, Pu241, Pu242, Pu243, and Am243, whose concentrations are the variables in the system of equations. The rates of elimination reactions through radiative capture (n,γ), β-decay, and fission were evaluated, as well as the production rates through (n,γ) conversion of the precursor nuclide. Additionally, the interaction probabilities at 1/v and cold neutron range (~1 meV), as well as at resonance energies Eₒ, for both (n,γ) and (n,f) reactions, were obtained from available literature data (Mughabghab S.F. Atlas of Neutron Resonances; Nuclear Data: EAF-2000, TENDL-2019, ENDF-B/VIII, JEFF-3.3).

[FIG. 12] (b) illustrates the concentrations over the operation time of the nuclides involved in the U238-Am243 cycle. The equilibrium concentrations are achieved from 10⁶ seconds to 10⁹ seconds. Concentration stability is reached starting from 10⁹ seconds, making the system stable. In this case, the equilibrium concentration of Pu239 was higher than the initial concentration of Pu239 inserted into the system.

This example approaches the fission on the fissile materials with MB (13) modulators in cold neutron range, in non-limit matter. Indeed, various of these fissile nuclides hold suitable resonances in the range of 0.04 to 1 eV. Such interval may be a good target to MR modulator running in one group of those resonances.

### Example 5

The U238-Am243 cycle heat and energy generation was analyzed. Table 6 plots the main results of the heat and energy evaluation in U238-Am243 cycle. The thermal energy produced up to 10⁷ seconds (1 day-1 month) was 67.94 kWₜh, while the equilibrium of thermal energy generation is achieved after 1 year of operation, reaching a value of 526 kWₜh, with 316 kWₑh production.

[FIG. 13] (b) illustrates the thermal energy in kWh of the MFCC system running in the U238-Am243 cycle. This equilibrium condition stays continuous as long as the concentrations in MX, K_{ef} and Source emission remain constant.

### Example 6

This example shows the physical behavior of the neutron spectrum generated in the MB moderator (13), helping the MB design. The analysis considers distinct temperature conditions and the influence of free-molecular thermal vibration model. The number of particles evaluated was 3000, running 850 interactions per particle. The spatial discretization takes 100 bins into spatial radial discretization. Each bin stands for the interval 0.005R (m). The moderator was rotating at 10³, 10⁴ and 10⁵ rpm. The material was PTFE-Graphite, with 85% of PTFE and 15% Graphite powder, density of 2.15 g·cm⁻³. It was considered all types of collision in the modulator, scattering and absorptions. The distribution of neutrons Dₙ(Eₘ, σ) was evaluated in each spatial and energetic position. The 2D and 3D collisions were evaluated. The 2D analysis was plotted.

[FIG. 14] (A) depicts the average energy Eₘ of the distribution of neutrons Dₙ(Eₘ, σ) taken each discrete radial bin into the MB moderator; consider with no thermal model, at room temperature. The index 1, 2 and 3 display different rotation.

[FIG. 14] (B) depicts the average energy Eₘ of the distribution of neutrons Dₙ(Eₘ, σ) taken each discrete radial bin up to 100 positions on a radium of 25 cm of the MB (13) moderator. It plots 1, 3 and 4 cases, in which 1 and 3 consider non thermal vibration, at room temperature. (1,2,3); and with free-molecular thermal model in 4, with 10³ rpm, at 223 K. A suitable design for MB (13) modulator was achieved with Np ~35, meaning R=10 cm, reaching minimum of 2.5±4 meV at 220 K, 800 rpm. A realistic thermal model for the density cool polymers in rotation should be between 1 and 4 data, adjusted this spectrum result. Therefore, it is possible that a realistic modulator with the adjustment of Tₘ temperature, wₙ and R_{MB} reproduces Eₘ close to 1 meV.

The thermal vibration phenomenon becomes competitive in interfering with the reduction of the velocity of the neutrons in matching their energy to the rotational energy of the medium. The thermal energy E_{T} becomes a limit on neutron average energy of the neutron distribution, however Eₘ reaches lower values than E_{T}, since there is negative feedback due to dynamic of the system forcing Eₘ be reduced.

### Example 7

In this example, we will explore the behavior of the neutron spectrum generated in the MR moderator (14) to better present the MR design.

FIG. 15 depicts the data from MR design. The neutron transport analysis was solving 2D collisions and absorptions, having 3000 particles and 900 collisions per particle, angular velocity from 10⁵ up to 10⁶ rpm, and taking MR on origin, discretizing 320 bins of radial groups. One can see that the Zirconyl and Graphite supply similar Dₙ(Eₘ, σ) for high Eₘ, when Eₘ is expressed in function of the radium R and angular velocity wₙ. It occurs since Eₘ~(wₙ·R)² and has non-dependence to the material of the moderator in high values of wₙ and R.

Material Zirconium Zr₇O₂, with 51% Zr90, 11.22% Zr91, 17.15% Zr92, 17.38% Zr94 was analyzed to be MR for matching the ~22 eV resonances of Th232. The position of MR was evaluated into MFCC1 and the angular velocity adjusted. The best position was achieved at 246 bins, achieving 22±7 eV. Translating such data for the real radium position of MR in MFCC1, one can achieve of LR of 60 cm and wₙ of 5.10⁵ rpm.

In the 106-value bin, one can find 6.5±5 eV in such dynamic material with L_{MR} and wₙ found on the curve. To repositioning MR in MFCC1, there is equivalence of (wₙ·L_{MR})² on origin to (wₙ·(R_{MR}+L_{MR})² to the R^{MR} real position. It means that LR of 26.5 cm, and wₙ of 3.10⁵ rpm, attend Eₒ~Eₘ in MFCC1.

### Example 8

This example deals with the criticality of the system MKi-Cfi. Let us consider a MFCC1 design having: a source FT(20) inside, with L_{FT} of 1 cm×6 cm placed at center. The length measurements are L_{PM} 7.5 cm PM (15); L_{MB1} 13.5 cm, L_{CF1} 1.5 cm, L_{MK1} 8 cm, L_{MB2} 14 cm, L_{CF2} 1.5 cm, L_{Mk2} 7 cm; L_{PMB} 8 cm L_{MR} 40 cm, L_{CC} 1.5 cm, L_{RF} 8 cm, support Lₛ 0.5 cm; H_{MFCC} 80 cm, H_{CC} and H_{CF} of 56 cm. The following materials were consider: MR (14) of graphite (2.25 g/cm³), MB (13) of graphite, PMB (24) of graphite (2.25 g/cm³), MK₁ and MK₂ (5) of light water, RF of PTFE (2.16 g/cm³), source FT (20) of deuterium gas, .support of steal (7.852 g/cm³), MX (3) L_{MX} 8 mm of Th232 in ThC (10.6 g/cm³), MY L_{MY} 10 mm of UO₂ (10.97 g/cm³), 5% enrichment in starting condition.

Recalling MY (77) matrix is introduced in MFCC1 to improve criticality in the starting operation period before the concentrations of the fissile materials reach equilibrium. Simulations of the multiplicative factor MK (5) were evaluated on MCNP6 code, showing the effectiveness of introducing the MK (5) near MY matrix to amplify neutrons produced by fission in the C F1 and CF2 chambers. MFCC1 was modelling in MCNP6 geometry. Natural and heavy water were used as material for MK (5); while UO₂ enriched uranium was used in MY (77). The results show that the criticality on the MK-fissile system holds 0.94495 for starting condition. This condition was used to achieve equilibrium concentrations in Th232-U238 and U238-Pu243 cycles on earlier examples 2 and 4.

### Example 9

The chemical processing module aids in separating the fissile products from the nuclides collected by the FdC collecting fluid but did not undergo fission. The fissile products are directed to a reservoir for future treatment. The residence time in this reservoir aids in reducing activity of nuclides with short half-lives.

The FdD decontaminated collecting fluid undergoes concentration adjustments with the solvent. Chelating agents are introduced to aid in collecting the fissile products converted into MX (3) and transport them to CF (16).

A variety of chelating complexes can be employed to address the diverse ionic valences of the fissile products in solution. The concentration of these reagents is controlled and adjusted by the chemical processing module.

In this decontamination line, different neutron spectra expose the contaminant solution, targeting their respective distinct nuclear resonances, which trigger the neutron activation of each of the respective fissile products. In each specific resonance spectrum, a long-lived radionuclide present in the PF reacts (n,γ) converting into a stable nuclide or a new short-lived radionuclide.

As a result, the diagram shows that the waste consists of stable nuclides or short-lived radionuclides. The chemical separators adjust concentrations and evaluate the outgoing fluids for the activity of the incoming and outgoing radionuclides. Chemical processing module holds gamma spectrometry, which intelligently finds the set of present radionuclides and adjusts the units to use at specific resonance energies.

The chemical processing module, the collecting and coolant fluid types are not on the scope of this matter.

TABLE 3
Material and geometric parameters in Th232-U238 Cycle.

| Comp. | Mat. | L_{R}[m] | Wn [rpm] |
|---|---|---|---|
| PM | Polyethylene | 0.075 | 0 |
| MB (1, 2) | PTFE-Graphite | 0.125 | 1.10³ |
| MK (1, 2) | Heavy or Light Water | 0.100 | 0 |
| MR | Zircaloy or Graphite | 0.60 | 6.10⁵ |
| PMB | Graphite | 0.120 | 1.10³ |
| CP | Zircaloy | 0.015 | 0 |
| CI (1, 2) | Zircaloy | 0.015 | 0 |
| FP | Li⁷(p, n) ou D(d, n), | 0.012 | 0 |
| | D(T, n) | | |
| RF | PTFE-Graphite | 0.080 | 0 |
| MX | Matrix Th232, ThC₂ | 0.005 | 0 |
| MY | Matrix U233-UO₂ (3%) | 0.003 | 0 |

TABLE 4
Material and geometric parameters in U238-Am243 Cycle.

| Comp. | Mat. | L_{R}[m] | Wn [rpm] |
|---|---|---|---|
| PM | Polyethylene | 0.075 | 0 |
| MB (1, 2) | PTFE-Graphite | 0.120 | 1.10³ |
| MK (1, 2) | Heavy or Light water | 0.100 | 0 |
| MR | Graphite | 0.260 | 5*10⁵ |
| PMB | PTFE-Graphite | 0.150 | 1.10³ |
| CP | Zircalloy | 0.015 | 0 |
| CI1 | Zircalloy | 0.015 | 0 |
| CI2 | Zircalloy | 0.015 | 0 |
| FP | Li⁷(p, n) | 0.012 | 0 |
| RF | PTFE-Graphite | 0.10 | 0 |
| MX | Matrix U238 natural, UC₂ | 0.005 | 0 |
| MY | Matrix UO₂, 3% enrich. | 0.003 | 0 |

TABLE 5
Thermal parameters and efficiency in Th232-U238 Cycle.

| Thermal parameters | T = 10⁵ s | T = 10¹⁴ s |
|---|---|---|
| Q (CF1 + CF2 + CC) | 50.47 | 26.58 |
| Q total (KWₜh) | 54.18 | 30.29 |
| Brayton Cycle Efficiency | 60 | 60 |
| Electric energy (KWₑh) | 32.50 | 18.17 |
| Electric efficiency (ef*KWth − KWₑh/ | 88 | 78 |
| ef*KWₜh) | | |

TABLE 6
Thermal parameters and efficiency in U238-Pu243 Cycle.

| Thermal parameters | T = 10⁵ s | T = 10¹⁴ s |
|---|---|---|
| Q (CF1 + CF2 + CC) | 64.23 | 523.19 |
| Q total (KWₜh) | 67.94 | 526.90 |
| Brayton Cycle Eficiency (ef) | 60 | 60 |
| Electric energy (KWₑh) | 40.76 | 316.14 |
| Electric efficiency (ef*KWth −KWₑh/ef*KWₜh) | 92 | 81 |

### INDUSTRIAL APPLICABILITY

The MFCC equipment and its arrangements, as described in this document, running in the Th232-U238 or U238-Am243 cycles, can generate heat for industry, chemical processes, residential heating, and electricity.

### REFERENCE SIGNS LIST

1. MC module of conversion of fertile material.
2. MF module of fission.
3. MX matrix of fertile material into CC.
4. MS module of source, include primary neutron source (FP).
5. MK module of static moderator for fission multiplicative
6. Collecting Fluid transport from CC to CF in {MC, MF, MS} dependent unit.
7. Compartment for fission into CF
8. Collecting Fluid transport from CC to CF in {MC, MS} and {MF, MS} independent unit.
9. Box for the ion accelerator.
10. RF reflector of neutrons.
11. CC conversion camera.
12. Cooling camera for cryogenic fluid in PM when MB applied.
13. MB moderator of cold neutron energy.
14. MR moderator of resonances in MC.
15. PM previously static moderator of the source
16. CF1 first camera of fission in multiple condition.
17. CF2 second camera of fission in multiple condition.
18. MF second module of fission in multiple condition.
19. Halo tube for ion accelerator.
20. Solid target of ion's accelerator and neutron's generation.
21. Central radial axis of the moderator and modulator units.
22. Central gear of the first rotating motor.
23. Radial halo gear of second rotating motor.
24. PMB moderator of low energy in MC.
25. PMB previously moderator of low energy in MF.
26. Internal culler compartment into CC for cooling fluid transport.
27. Internal culler compartment into CF for cooling fluid transport.
28. Internal fission-fluid compartment into CF.
29. Internal collecting-fluid compartment into CC.
30. Multiplicative Fission and Converter Core-MFCC
31. HC_{A}—Cooling-fluid transport for accelerator target cooling.
32. HC_{CF}—Cooling-fluid transport for CF cooling.
33. HC_{CC}—Cooling-fluid transport for CC cooling.
34. Fd—PF-free collecting-fluid for MFCC.
35. FdC—Contaminant collecting-fluid (fissile-fluid) from MFCC.
36. Input link of the Fd refresh fluid.
37. FdD—decontaminated-fluid from RSS units.
38. Fluid transport from PQ to RF RT.
39. CPM Chemical Processing Module
40. VSHL FPR—Very Short Half-Live Fission Product Repository
41. Cooling input tube of CF
42. Cooling output tube of CF
43. Cooling input tube of acceleration camera (CA).
44. Cooling output tube of acceleration camera (CA)
45. Cooling input tube of CC.
46. Input collecting-fluid tube to CC.
47. Top ring tube of input collecting fluid in CC.
48. Bottom ring tube of the input collet fluid in CC.
49. Top ring tube of the output cooling fluid of CC.
50. Bottom ring tube of the input cooling fluid of CC.
51. The top ring tube of the input collet fluid in CF.
52. Bottom ring tube of the output collecting fluid in CF.
53. Bottom ring tube of the input cooling fluid of CF.
54. Top ring tube of the output cooling fluid of CF.
55. Culler halo cylinder box of the source ion target.
56. Link of the bottom collect ring to CC.
57. Top link of the collecting fluid from CC to CF.
58. Bottom output link of the collecting fluid from CF.
59. External output link to the collecting fluid.
60. Heat exchanger of accelerator target.
61. Heat exchanger of the CF cooling fluid.
62. Heat exchanger of the CC cooling fluid.
63. Input of the working fluid FdT.
64. Output of the working fluid FdT.
65. High speed permanent magnet motor for MR.
66. High speed permanent magnet motor for MB and PMB.
67. Box of Heat-Exchanger fluids.
68. Top support-holding of PM, MK, CC and CF, and accelerator box.
69. Lateral support-holding of RF
70. Base support-holding of motors of high speed.
71. Speed measurement of motor 1
72. Speed measurement of motor 2
73. Helix of MR support holding.
74. Helix of PM and MB support holding.
75. Superior magnetic support for MR.
76. Inferior magnetic support for MR.
77. Matrix MY of fission material in CFs to support multiplication.

### CITATION LIST

Techno-economic Comparison of Geological Disposal of Carbon Dioxide and Radioactive Waste IAEA-TECDOC-1758 h IAEA-TECDOC-1758/978-92-0-110114-3 244 pages.
Planning and Design Considerations for Geological Repository Programmes of Radioactive Wast, IAEA-TECDOC-1755/978-92-0-109914-3 80 pages Date published: 2014.
Duderstadt, James J, Hamilton, Louis J., Nuclear Reactor Analysis, John Wiley & Sons, Inc, Michigan, 1976
Mughabghab, S.F., Atlas of Neutron Resonances, Resonances Parameters and Thermal Cross Sections Z=1-100, 5^{th} Editon, National Nuclear Data Center, Brookhaven National Laboratory, USA, Elsevier, ISBN: 978-0-444052035-7.
JEFF-3.3, Joint Evaluated Fission and Fusion File (JEFF), NEA Data Bank, oecd-nea.org/dbdata/jeff/jeff33/index.html, Accessed 2023.
EAF-2000; Neutron-induced cross-section library, The European Activation, File EAF-99-JEFF-3 activation file, 2000. doi.org/10.1080/00223131.2000.10875007. Published online: 27 Aug. 2014.
TENDL-2019; TALYS-based evaluated nuclear data library, A.J. from: Koning, D. Rochman, J. Sublet, N. Dzysiuk, M. Fleming and S. van der Marck, TENDL: Complete Nuclear Data Library for Innovative Nuclear Science and Technology, Nuclear Data Sheets 155 (2019).
ENDF-B/VIII.0—Evaluated Nuclear Data Library National Nuclear Data, www.nndc.bnl.gov/endf-b8.0/index.html Accessed: May 2003.
Durkee J.W. et al., MCNP6 moving Objects part I: Theory, Prog. Nucl. Energy, 2016.
Durkee J.W. et al. MCNP6 moving objects. Part II: Simulations. Prog. Nucl. Energy, 2016.
Harrisson G., Li G., Van Der Ende B., Rogger R. B., Tun Z. Simulation of a rotating neutron moderator, Nuclear Instruments and Methods in Physics Research, Section A: Accelerators, Spectrometers, Detectors and Associated Equipment, Vol. 959, 11 Apr. 2020, 163562.

### PATENT LITERATURE

Wo2016/060867 a1, Smick, Noah, et al. Generating Neutrons Using a Rotating Neutron Source Material.
US2023/0024338, Mark Reed et al, Skewed-Pin (SPIN) Moderator locks for Nuclear Reactors, 2023.
Campos, Tarcisio Passos Ribeiro de; Campos, Alberto Mizrahy. submitting patent PCT/BR2023/050225, Date of Receipt: 1 Jul. 2023, Receiving Office: National Institute of Industrial Property (Brazil)).

1. Equipment, Multiplicative Fission and Conversion Core—MFCC (30), characterized to optimize the rate of neutrons reactions of the types (n,γ) radiative capture of X nuclides, and (n,f) fission of Y nuclides, generating a neutron distribution (Dₙ(Eₘ, σ), Eₘ—average energy, σ—standard deviation) in a selective domain of the neutron spectrum adjusted to a respective type of XS cross section of X and Y nuclides.

2. [MFCC according to claim 1 is characterized to MFCC1, MFCC2 and MFCC3 arrangements operates in one of the Th232-U238 and U238-Am243 cycles, where X is one of the fertile Th232 and U238 nuclides, and MR modulate Eₘ adjusting to Eₒ (Eₘ~Eₒ) where Eₒ is one of the well-defined resonance energies of 21.8 eV and 23.4 eV of Th232, and 6.65 eV of U238, optimizing X(n,γ) Y conversion reaction to fissile Y nuclides; and MB modulator adjusting to Eₘ into the cold neutron spectra optimizing Y(n,f) when XS(n,f) hold 1/v behavior; and MR modulator adjusting Eₘ~Eₒ with Eₒ energy of resonance of Y nuclides, when XS (n,f) is type resonant.]

3. [MFCC according to claims 1 and 2 is characterized to grouping the following modules: MS (4)—source module, MF (2)—fission module, MC (1)—conversion module, composing one of the sets: serial {MC (1), MF (2), MS (4)} namely MFCC1 arrangement, parallel {MC (1), MS (4)} and {MF (2), MS (4)} namely MFCC2 arrangement, individual {M, MS (4)} in which M is assumed to operate as MC (1) and MF (2), in distinct periods, namely MFCC3 arrangement; whose modules MC (1) consist of {RF (10), CC (11), MR (14), PMB (24)}, MF (2) can be repeat (MF (2,18)) and consist of one of the sets {MK (5), CF (16), MB (13)} and {MK (5), CF (16), MR (14), PMB (24)}, and MS (4) consist of {PM (15), FT (20)}.]

4. [MFCC according to claims 1 to 3 characterized to PM (15) represents a static pre-moderator, PMB (24) a dynamic low-energy pre-moderator, MR (14) a dynamic modulator to match a well-define resonance energy, MB (13) a dynamic low-energy modulator to cold neutrons domain, MK (5) a static moderator, RF (10) a static neutron reflector, FT (20) a neutron source inserted in PM (15), CC (10) a chamber for fertile material, and CFs (16, 17) fissile chamber, with both CC (11) and CFs (16,17) subdivided into two compartments (26,29) and (27,28), respectively; in which RF (10), PMB (24), PM (15), MR (14), MB (13), MK (5) are solid cylindrical halos arranged on the same axial axis (21).]

5. [MFCC according to claims 1 to 4 is characterized to the modulators of the neutron distribution Dₙ(Eₘ, σ) be of two types: low-energy modulator—MB (13) with Eₘ in the domain of cold neutrons; and, resonant modulator—MR (14) with Eₘ approaching the resonance energy Eₒ; in which the Ri internal and Re external radii of the cylindrical MB and MR halos and their operational angular velocity wₙ hold Ri and Re values in the interval of 0.1 up to 1.5 m, and wₙ from 10² up to 10⁶ rpm.]

6. [MFCC, according to claims 1 to 5, is characterized to MFCC1 and MFCC2 containing a solid material matrix MX (3) consisting of fertile X nuclides within inner wall of compartment (29) into CC (11), and, a solid material matrix MY (77) of fissile Y nuclides within inner wall of compartment (28) into CF (16,17) chambers; and, MFCC3 containing in its unique C chamber the material matrix Mi (78) filled with one of i being X, and Y; in which the cylinder chambers CC (MX) and CF (MY).]

7. [MFCC, according to claims 1 to 6 is characterized to have a circulating Fd (6) collecting fluid circuit, being Fd (34) a solution that flows inter compartment (29), through the matrix MX (3), removing the fissile Y nuclides and transferring them to inter compartment (28) in CF (16, 17) fissile chambers, in a continuously (46) inlet and (59) outlet flows over time; subsequently, the FdC (35) contaminant fluid carrying fission products PF, is transferred to the chemical processing module (CPM) (39) for treatment and recirculation.]

8. [MFCC, according to claims 1 to 7, is characterized to have MFCC1 and MFCC2 arrangements holding independent HC (31,32,33) cooling circuits, HC_{CC} (45, 46, 62) to remove Q_{c} heat from the CC (11) chamber in compartment (26), HC_{CF} (41, 42, 61) to remove Q_{F} (61) heat from one or more CF chambers (16, 17) in compartments (27), and HC_{A} (43, 44, 62) to remove QA (60) heat from the target (20) of the neutron source in compartment (55); in which the heats are transferred by the heat exchangers (60, 61, 62) to the FdT working fluid (63 in, 64 out); while MFCC3 hold HC_{A} and one HC circuit.].
